(19) United States
(12) Patent Application Publication
(10) Pub. No.: US 2024/0220446 A1
(43) Pub. Date: Jul. 4, 2024

(54) METHODS, SYSTEMS, AND APPARATUSES FOR DYNAMIC SIMULTANEOUS MULTI-THREADING (SMT) SCHEDULING TO MAXIMIZE PROCESSOR PERFORMANCE ON HYBRID PLATFORMS

(71) Applicant: Intel Corporation, Santa Clara, CA (US)

(72) Inventors: Deepak Samuel Kirubakaran, Hillsboro, OR (US); Rajshree Chabukswar, Sunnyvale, CA (US); Zhongsheng Wang, Camas, WA (US); Russell Fenger, Beaverton, OR (US); Asit Kumar Verma, Bangalore (IN); DK Deepika, Secunderabad (IN); Yevgeni Sabin, Haifa (IL); Daniel J. Rogers, Folsom, CA (US); Cameron T. Rieck, Portland, OR (US)

(21) Appl. No.: 18/149,072

(22) Filed: Dec. 30, 2022

(51) Int. Cl. G06F 15/80; G06F 9/48

(52) U.S. Cl. CPC G06F 15/80; G06F 9/48

(57) ABSTRACT

Techniques for implementing dynamic simultaneous multi-threading (SMT) scheduling on a hybrid processor platforms are described. In certain examples, a hardware processor includes a first plurality of physical processor cores of a first type to implement a plurality of logical processor cores of the first type; a second plurality of physical processor cores of a second type, wherein each core of the second type is to implement a plurality of logical processor cores of the second type; and circuitry to: determine if a set of threads of a foreground application is to use more than a lower threshold (e.g., a threshold number (e.g., one) of logical processor cores) and less than or equal to an upper threshold (e.g., a total number of the first plurality of physical processor cores of the first type and the second plurality of physical processor cores of the second type), and disable a second logical core of a physical processor core of the second type, and not disable a first logical core of the physical processor core of the second type, in response to a determination that the set of threads of the foreground application is to use more than the lower threshold number of logical processor cores and less than or equal to the upper threshold (e.g., the total number of the first plurality of physical processor cores of the first type and the second plurality of physical processor cores of the second type).

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF DRAWINGS

Various examples in accordance with the present disclosure will be described with reference to the drawings, in which:

FIG. 1 illustrates a computer system including a processor core according to some examples.

FIG. 2 illustrates thread runtime telemetry circuitry according to some examples.

FIG. 3 illustrates an example format of a control register to enable thread runtime telemetry according to some examples.

FIG. 4 illustrates a computer system including a first plurality of physical processor cores of a first type and a second plurality of physical processor cores of a second type, where each core of the first type is to implement a plurality of logical processor cores according to some examples.

FIGS. 5A-5B illustrate an example format for telemetry data (e.g., per logical processor core) according to some examples.

FIG. 6 illustrates a data structure for telemetry data storing an energy efficiency capability value and a performance capability value for each logical processor core of a computer system according to some examples.

FIG. 7 is a flow diagram illustrating operations of a method of performing dynamic simultaneous multi-threading (SMT) scheduling according to some examples.

FIG. 8 is a flow diagram illustrating operations of another method of performing dynamic simultaneous multi-threading (SMT) scheduling according to some examples.

FIG. 9 illustrates an example computing system.

FIG. 10 illustrates a block diagram of an example processor and/or System on a Chip (SoC) that may have one or more cores and an integrated memory controller.

FIG. 11A is a block diagram illustrating both an example in-order pipeline and an example register renaming, out-of-order issue/execution pipeline according to examples.

FIG. 11B is a block diagram illustrating both an example in-order architecture core and an example register renaming, out-of-order issue/execution architecture core to be included in a processor according to examples.

FIG. 12 illustrates examples of execution unit(s) circuitry.

FIG. 13 is a block diagram of a register architecture according to some examples.

FIG. 14 illustrates examples of an instruction format.

FIG. 15 illustrates examples of an addressing information field.

FIG. 16 illustrates examples of a first prefix.

FIGS. 17A-17D illustrate examples of how the R, X, and B fields of the first prefix in FIG. 16 are used.

FIGS. 18A-18B illustrate examples of a second prefix.

FIG. 19 illustrates examples of a third prefix.

FIG. 20 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for implementing dynamic simultaneous multi-threading (SMT) scheduling to maximize processor performance on hybrid platforms.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. Software may request execution of a (e.g., software) thread. An operating system (OS) may include a scheduler (e.g., “O.S. scheduler”) to schedule execution of (e.g., software) threads on a hardware processor, e.g., to schedule execution of (e.g., software) threads on one or more logical processors (e.g., one or more logical processor cores) of the hardware processor. Each logical processor may be referred to as a respective central processing unit (CPU).

In certain examples, a hardware processor implements multi-threading (e.g., multithreading), e.g., executing multiple threads simultaneously on one physical processor core. In certain examples, multi-threading is temporal multi-threading (e.g., super-threading), for example, where only one thread of instructions can execute in any given pipeline stage at a time. In certain examples, multi-threading is simultaneous multi-threading (SMT) (e.g., Intel® Hyper-Threading), for example, where instructions from more than one thread can be executed in any given pipeline stage at a time. In certain examples, SMT allows two (or more) concurrent threads to run on a single physical processor core, e.g., the single physical processor core being exposed to software (e.g., an operating system) as a first logical processor core to execute a first thread and a second logical processor core to execute a second thread.

In certain examples, SMT improves multi-threaded (MT) performance by virtualizing a physical processor core (e.g., an SMT physical processor core) into a plurality of logical processors (e.g., logical processor cores). In certain examples, all logical processors (e.g., logical processors cores) of a hardware processor are exposed to an operating system (executing on the hardware processor) as individual logical processors (e.g., logical processor cores). In certain examples, this abstraction allows the operating system to schedule software threads across all logical processors (e.g., logical processor cores) available, thereby maximizing throughput and multi-threaded (MT) performance. However, in certain examples there is an issue with the underlying SMT physical processor core's resources (e.g., fetch circuit, decode circuit, execution circuit, etc.) are shared among the logical processors, and thus performance of each individual active logical processor (e.g., logical processor core) is significantly lower than the performance of the physical SMT core when another “sibling” logical thread(s) is active on the same physical SMT core (e.g., where there are a plurality of logical processor cores being active on the same physical SMT core). This leads to poor performance and responsiveness on certain workloads, e.g., lightly threaded workloads initiated by user, when concurrent background threads start competing for processor (e.g., central processing unit (CPU)) time on the same SMT physical processor core. Further, certain processors (e.g., as returned by a core type request by the OS) do not differentiate between a logical core and physical (e.g., SMT) core.

In certain examples, an application (e.g., software) that has a user start it and/or interact with it is referred to as a foreground application, e.g., and an application that runs independently of a user is referred to as a background application. In certain examples, foreground versus background is a priority level assigned to programs running (e.g., not “stopped”) in a multitasking environment, e.g., where the foreground (FG) contains the application(s) the user is working on (for example, an application that is to receive input(s) from a user and/or provide output to the user, e.g., via a graphical user interface (GUI)), and the background (BG) contains the application(s) that are run behind the system (e.g., without user interaction).

Examples herein are directed to methods and circuitry to allow a thread of (e.g., foreground) application to use a physical SMT core in isolation (e.g., disabling all but the single logical processor core of the physical SMT core being used by the thread), e.g., but if the (e.g., foreground) application is only using a certain threshold of (e.g., 2) cores, then allow another (e.g., background) (e.g., MT) application to use the rest of the free (e.g., unused) physical SMT core(s) for its usage, e.g., maximizing both foreground and background performance.

In certain examples, an asymmetric platform (e.g., processor) utilizes different types of cores, e.g., (i) a first type of processor core (e.g., a lower power, lower maximum frequency, and/or more energy efficient core) (e.g., an efficient core (“E-core”)) (e.g., “little” core or “small” core) and (ii) and a second, higher performance type of processor core (e.g., a higher power and/or higher frequency core) (e.g., a performance core (“P-core”)) (e.g., “big” core). In certain examples, one of the types of cores utilizes SMT (e.g., each of its physical processor cores implements a plurality of logical processor cores), for example, and the other type of core does not use SMT (e.g., each of its physical processor cores implements only a single logical processor core). In certain examples, an efficient core (“E-core”) runs at a (maximum) lower frequency, and thus execute instructions with lower performance compared to a performance core (“P-core”).

In certain examples, this issue with the underlying SMT physical processor core's resources being shared among the logical processors causing the performance of each individual active logical processor (e.g., logical processor core) to be significantly lower than the performance of the physical SMT core when another “sibling” logical thread(s) is active on the same physical SMT core is even more prevalent on hybrid platforms (e.g., hybrid processors) that include a first set of cores that do not support SMT and a second set of cores that support SMT. For example, in order to maximize the performance for foreground applications (e.g., foreground processes) on a hybrid platform (e.g., hybrid processor), certain OSes attempt to restrict background tasks to non-SMT cores (e.g., E-cores) via a corresponding (e.g., “small only”) scheduling policy. However, such a scheduling policy causes a significant performance degradation for user-initiated multi-threaded workloads (e.g., compiler, render, etc.) running as “background”. Hence there is a need for a dynamic solution that delivers core isolation for lightly threaded foreground tasks while not compromising performance on user-initiated MT background tasks when no critical foreground task is active on the system.

Examples herein are directed to methods and circuitry to maximize SMT performance on hybrid system (e.g., processor) platforms by: (i) providing user-initiated (e.g., lightly threaded) critical compute intensive tasks in the foreground the necessary SMT core isolation (e.g., disabling all but a single logical processor core of a physical SMT core that is to be used) on SMT core(s) (e.g., certain P-cores) when it runs concurrently in a multi-threaded background (e.g., “noisy”) environment, and/or (ii) allowing user-initiated critical multi-threaded background tasks (e.g., compilation, render, etc.) to run on SMT core(s) (e.g., certain P-cores) when desired, e.g., without being restricted by a static (e.g., “small only”) scheduling configuration for background tasks. In certain examples, the scheduling configuration is selected with an operating system, e.g., an operating system's scheduler.

One software-based solution to address this issue includes static OS core parking policies that attempts to provide core isolation by parking logical threads based on thread concurrency and utilization and static scheduling policies while restricting background tasks only to core(s) that do not support SMT (e.g., certain E-cores). However, such static OS parking policies fail to deliver necessary core isolation for critical threads when they run concurrently in a multi-threaded background environment, e.g., high concurrency and overall utilization (for example, average CPU utilization, e.g., “C0”). Even in absence of critical tasks in foreground, configuring static OS scheduling policy for background tasks to “small only” significantly degrades performance of user-initiated MT tasks (e.g., compilation, render, etc.) that require high performance. Certain examples herein allow an OS to implement SMT isolation support, e.g., while running concurrent scenarios of mixed quality of service (QOS) (e.g., both foreground and background applications).

Certain examples herein detect instances when core isolation is to be used based on concurrency (e.g., of threads running on the processor) and/or utilization of the user-initiated (e.g., in contrast to system-initiated) critical foreground tasks running on the system and the nature of the system (e.g., system-on-a-chip (SoC)) workload running on the system (e.g., sustained SoC workload due to high multi-threaded background activity). When lightly threaded compute intensive critical tasks are detected to run in a noisy sustained background environment, certain examples herein isolate the SMT core's resources to dedicate them for the critical task scheduled on the active logical processor of the SMT core by force parking sibling logical processor(s) that share the SMT core's resources, e.g., which temporarily restricts compute resources for the multi-threaded background tasks running on the system to the subset of remaining available cores. When compute requirements on the critical task change due to low utilization and/or highly concurrency, certain examples herein do not apply the core isolation via SMT sibling parking, e.g., and a less restrictive (e.g., small or idle) scheduling policy is used by the OS. In one example, a “small or idle” scheduling policy causes the scheduling of a thread to attempt to schedule a task (e.g., thread) to an idle efficient core (e.g., E-core) (e.g., small core) (e.g., non-SMT core) and if none are available (e.g., no efficient cores are idle), then to attempt to schedule the task to an idle performance core (e.g., P-core) (e.g., big core) (e.g., SMT core). In another example, a scheduling policy causes the scheduling of a thread to attempt to schedule a task (e.g., thread) to an idle non-SMT physical core and if none are available (e.g., no non-SMT cores are idle), then to attempt to schedule the task to an idle SMT physical core, for example, and if none of those are available, to attempt to schedule the task to an idle logical core of an SMT core.

In certain examples, a processor generates “capability” values to differentiate logical processors (e.g., CPUs) with different (e.g., current) computing capability (e.g., computing throughput). In certain examples, a processor generates capability values that are normalized in a (e.g., 256, 512, 1024, etc.) range. In certain examples, a processor is able to estimate how busy and/or energy efficient a logical processor (e.g., CPU) is (e.g., on a per class basis) via the capability values, e.g., and an OS scheduler is to utilize the capability values when evaluating performance versus energy trade-offs for scheduling threads.

In certain examples, the performance (Perf) capability value of a logical processor (e.g., CPU) represents the amount of work it can absorb when running at its highest frequency, e.g., compared to the most capable logical processor (e.g., CPU) of the system. In certain examples, the performance (Perf) capability value for a single logical processor (e.g., CPU) is a value (e.g., an 8-bit value indicating values of 0 to 255) that specifies the relative performance level of the logical processor, e.g., where higher values indicate higher performance and/or the lowest performance level of 0 indicates a recommendation to the OS to not schedule any threads on it for performance reasons.

In certain examples, the energy efficiency (EE) capability value of a logical processor (e.g., CPU) represents its energy efficiency (e.g., in performing processing). In certain examples, the energy efficiency (EE) capability value of a single logical processor (e.g., CPU) is a value (e.g., an 8-bit value indicating values of 0 to 255) that specifies the relative energy efficiency level of the logical processor, e.g., where higher values indicate higher energy efficiency and/or the lowest energy efficiency capability of 0 indicates a recommendation to the OS to not schedule any software threads on it for efficiency reasons. In certain examples, an energy efficiency capability of the maximum value (e.g., 255) indicates which logical processors have the highest relative energy efficiency capability. In certain examples, the maximum value (e.g., 255) is an explicit recommendation for the OS to consolidate work on those logical processors for energy efficiency reasons.

In certain examples, the functionality discussed herein (e.g., the core isolation via the parking of one or more SMT sibling logical core) is implemented as a hardware-based solution, e.g., using thread runtime telemetry (e.g., at nanosecond granularity) circuitry (e.g., Intel® Thread Director circuitry, e.g., microcontroller) to dynamically park an SMT core's logical core sibling(s) (e.g., when concurrent scenarios are executed). In certain examples, a processor (e.g., via non-transitory machine-readable medium that stores power management code (e.g., p-code)) determines, using per energy performance preference (EPP) group utilization and quality of service (QoS), if there is limited threaded high QoS and/or low EPP activity (e.g., foreground threads) and multi-threaded low QoS and/or high EPP activity (e.g., background threads). In certain examples, if so, then the processor (e.g., via non-transitory machine-readable medium that stores power management code (e.g., p-code)) will populate a data structure that stores telemetry data (e.g., per logical processor core) to cause the dynamic parking of an SMT core's logical core sibling(s). In certain examples, such a data structure stores the data of thread runtime telemetry circuitry, e.g., the data of (i) Hardware Guide Scheduler (HGS) (or HGS+) circuitry or (ii) Thread Director circuitry. In certain examples, the processor is to cause a write of a (e.g., capability) value (e.g., zero or about zero) to the entry or entries of the sibling logical processor core(s) of a logical processor core of an SMT physical processor core to hint to the OS (e.g., to the OS scheduler) to avoid using those sibling logical processor core(s), e.g., to avoid scheduling a thread on those sibling logical processor core(s).

In certain examples, the thread runtime telemetry circuitry (e.g., (i) Hardware Guide Scheduler (HGS) (or HGS+) circuitry or (ii) Thread Director circuitry) (e.g., via its corresponding data structure) communicates numeric performance and numeric power efficiency capabilities of each logical core in a certain (e.g., 0 to 255) (e.g., 0 to 511) (e.g., 0 to 1023) range to the OS in real-time. In certain examples, when either the performance or energy capabilities efficiency of a logical processor core (e.g., CPU) is zero, the hardware dynamically adapts to the current instruction mix and recommends not scheduling any tasks on such logical core.

In certain examples, the functionality discussed herein (e.g., the core isolation via the parking of one or more SMT sibling logical cores) is implemented as a non-transitory machine-readable medium that stores system code, e.g., system code that, when executed, dynamically parks an SMT core's logical core sibling(s). In one example, the non-transitory machine-readable medium stores a system software driver (e.g., Intel® Dynamic Tuning Technology (DTT) software driver), for example, a system software driver that, when executed, dynamically optimizes the system for performance, battery life, and thermals.

Examples herein thus deliver unique hybrid processor (e.g., utilizing SMT cores and non-SMT cores) differentiation by delivering significant performance gains by better utilization of cores that have SMT (e.g., hyper-threading) enabled. Examples herein utilize core isolation via the parking of one or more SMT sibling logical cores to deliver significant responsiveness and performance gains during concurrent usages involving lightly threaded tasks (e.g., application launch, page load, speedometer (e.g., that tests a browser's web app responsiveness by timing simulated user interactions), etc.) running with multi-threaded background tasks (e.g., compilation and/or render in background). Examples here are directed to a less restrictive scheduling for processors (e.g., platforms) that allows user-initiated multi-threaded background tasks (e.g., compiler and/or renderer) to take advantage of SMT processor cores when desired.

Certain (e.g., default) OS scheduling policies on hybrid platforms (e.g., utilizing SMT cores and non-SMT cores) do not provide flexibility to customers. In certain examples, scheduling background thread(s) on a less powerful non-SMT physical processor core (e.g., efficient core (E-core)) (e.g., small core) only is too restrictive because the (e.g., multi-threaded) background work initiated by a user (e.g., compile and/or render) cannot take advantage of a more powerful SMT physical processor core (e.g., performance core (P-core)) (e.g., big core). In certain examples, scheduling background thread(s) on a less powerful non-SMT physical processor core (e.g., efficient core (E-core)) (e.g., small core) or an idle SMT physical processor core (e.g., performance core (P-core)) (e.g., big core) impacts foreground (FG) performance during concurrent usages (e.g., due to sharing of SMT core with critical threads from lack of core isolation). The above shortcomings are overcome with dynamic SMT scheduling disclosed herein, e.g., that provides core isolation via forced core parking of logical SMT sibling processors when desired (e.g., when necessary) while allowing a less restrictive (e.g., “small or idle”) scheduling policy for user-initiated background tasks (e.g., compiler/render, etc.) running on the system to take advantage of SMT physical processor cores (e.g., performance cores (P-cores)) (e.g., big cores). Being able to dynamically achieve SMT isolation at run time allows an OS (e.g., OS scheduler) to use a less restrictive scheduling policy (e.g., “small or idle”) for user-initiated background tasks without concerns on impact to foreground responsiveness.

Certain examples herein do not totally disable SMT (e.g., for an entire processor), e.g., do not disable SMT either through a hardware initialization manager (e.g., Basic Input/Output System (BIOS) firmware or Unified Extensible Firmware Interface (UEFI) firmware) or by having the OS only schedule work on one of the threads.

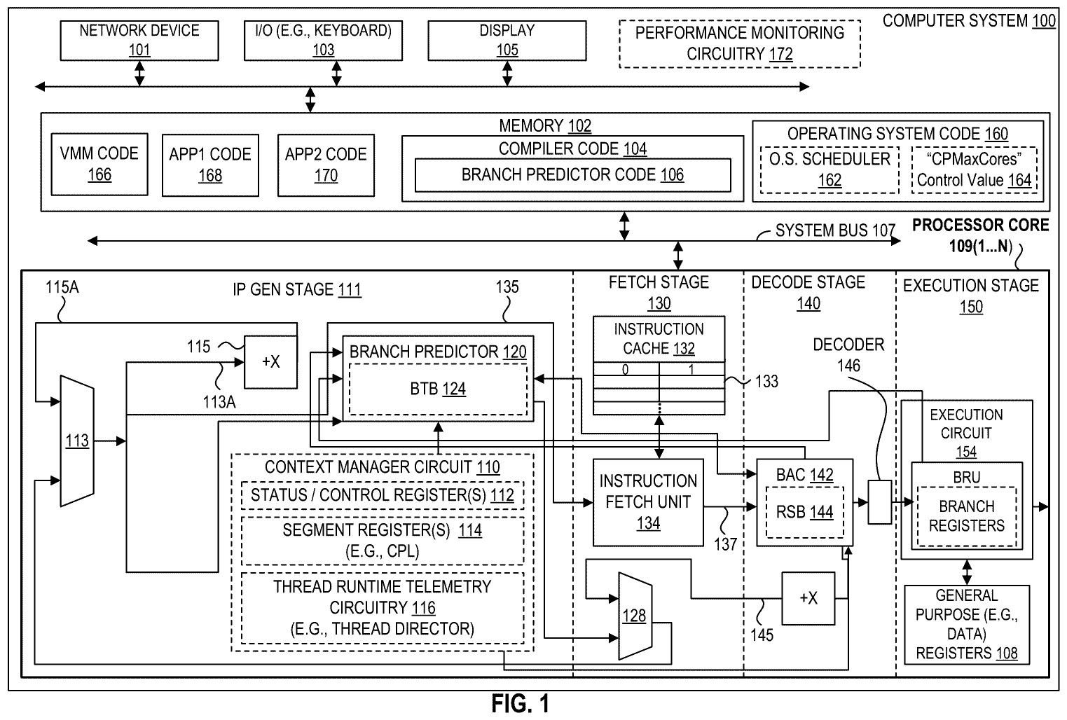

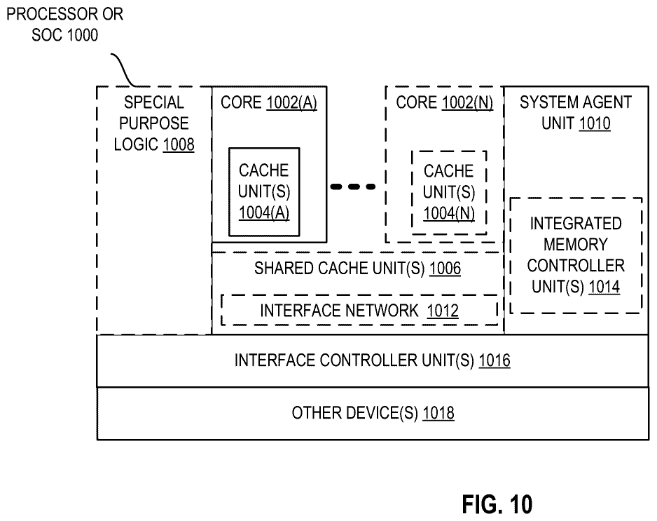

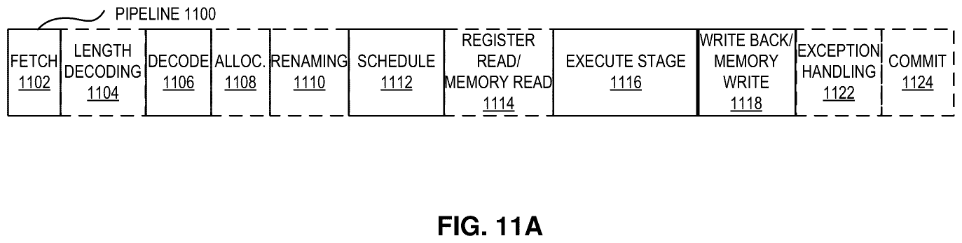

FIG. 1 illustrates a computer system including a processor core according to some examples. Processor core 109 includes multiple components (e.g., microarchitectural prediction and each ing mechanisms) that may be shared by multiple contexts (e.g., virtualized as a plurality of logical processors implemented on a single SMT core). For example, branch target buffer (BTB) 124, instruction each e 132, and/or return stack buffer (RSB) 144 may be shared by multiple contexts. Certain examples include a context manager circuit 110 to maintain multiple unique states associated with a plurality of contexts simultaneously, and switch active contexts among those tracked by the context manager circuit. In certain examples, processor core 109 is an instance of processor core 1190 in FIG. 11B.

Depicted computer system 100 includes a branch predictor 120 and a branch address calculator 142 (BAC) in a pipelined processor core 109(1)-109(N) according to examples of the disclosure. Referring to FIG. 1, a pipelined processor core (e.g., 109(1)) includes an instruction pointer generation (IP Gen) stage 111, a fetch stage 130, a decode stage 140, and an execution stage 150. In one example, computer system 100 includes multiple cores 109(1-N), where N is any positive integer. In another example, computer system 100 includes a single core.

In certain examples, each processor core 109(1-N) instance supports multi-threading (e.g., executing two or more parallel sets of operations or threads on a first and second logical core), and may do so in a variety of ways including time sliced multi-threading, simultaneous multi-threading (e.g., where a single physical core provides a logical core for each of the threads that physical core is simultaneously multi-threading), or a combination thereof (e.g., time sliced fetching and decoding and simultaneous multi-threading thereafter). In the depicted example, each single processor core 109(1) to 109(N) includes an instance of branch predictor 120. Branch predictor 120 may include a branch target buffer (BTB) 124.

In certain examples, branch target buffer 124 stores (e.g., in a branch predictor array) the predicted target instruction corresponding to each of a plurality of branch instructions (e.g., branch instructions of a section of code that has been executed multiple times). In the depicted example, a branch address calculator (BAC) 142 is included which accesses (e.g., includes) a return stack buffer 144 (RSB). In certain examples, return stack buffer 144 is to store (e.g., in a stack data structure of last data in is the first data out (LIFO)) the return addresses of any CALL instructions (e.g., that push their return address on the stack).

Branch address calculator (BAC) 142 is used to calculate addresses for certain types of branch instructions and/or to verify branch predictions made by a branch predictor (e.g., BTB). In certain examples, the branch address calculator performs branch target and/or next sequential linear address computations. In certain examples, the branch address calculator performs static predictions on branches based on the address calculations.

In certain examples, the branch address calculator 142 contains a return stack buffer 144 to keep track of the return addresses of the CALL instructions. In one example, the branch address calculator attempts to correct any improper prediction made by the branch predictor 120 to reduce branch misprediction penalties. As one example, the branch address calculator verifies branch prediction for those branches whose target can be determined solely from the branch instruction and instruction pointer.

In certain examples, the branch address calculator 142 maintains the return stack buffer 144 utilized as a branch prediction mechanism for determining the target address of return instructions, e.g., where the return stack buffer operates by monitoring all “call subroutine” and “return from subroutine” branch instructions. In one example, when the branch address calculator detects a “call subroutine” branch instruction, the branch address calculator pushes the address of the next instruction onto the return stack buffer, e.g., with a top of stack pointer marking the top of the return stack buffer. By pushing the address immediately following each “call subroutine” instruction onto the return stack buffer, the return stack buffer contains a stack of return addresses in this example. When the branch address calculator later detects a “return from subroutine” branch instruction, the branch address calculator pops the top return address off of the return stack buffer, e.g., to verify the return address predicted by the branch predictor 120. In one example, for a direct branch type, the branch address calculator is to (e.g., always) predict taken for a conditional branch, for example, and if the branch predictor does not predict taken for the direct branch, the branch address calculator overrides the branch predictor's missed prediction or improper prediction.

In certain examples, core 109 includes circuitry to validate branch predictions made by the branch predictor 120. Each branch predictor 120 entry (e.g., in BTB 124) may further include a valid field and a bundle address (BA) field which are used to increase the accuracy and validate branch predictions performed by the branch predictor 120, as is discussed in more detail below. In one example, the valid field and the BA field each consist of one bit one-bit fields. In other examples, however, the size of the valid and BA fields may vary. In one example, a fetched instruction is sent (e.g., by BAC 142 from line 137) to the decoder 146 to be decoded, and the decoded instruction is sent to the execution circuit (e.g., unit) 154 to be executed.

Depicted computer system 100 includes a network device 101, input/output (I/O) circuit 103 (e.g., keyboard), display 105, and a system bus (e.g., interconnect) 107.

In one example, the branch instructions stored in the branch predictor 120 are pre-selected by a compiler as branch instructions that will be taken. In certain examples, the compiler code 104, as shown stored in the memory 102 of FIG. 1, includes a sequence of code that, when executed, translates source code of a program written in a high-level language into executable machine code. In one example, the compiler code 104 further includes additional branch predictor code 106 that predicts a target instruction for branch instructions (for example, branch instructions that are likely to be taken (e.g., pre-selected branch instructions)). The branch predictor 120 (e.g., BTB 124 thereof) is thereafter updated with a target instruction for a branch instruction. In one example, software manages a hardware BTB, e.g., with the software specifying the prediction mode or with the prediction mode defined implicitly by the mode of the instruction that writes the BTB also setting a mode bit in the entry.

Memory 102 may include operating system (OS) code 160, virtual machine monitor (VMM) code 162, first application (e.g., program) code 168, second application (e.g., program) code 170, or any combination thereof.

In certain examples, OS code 160 is to implement an OS scheduler 162, e.g., utilizing thread runtime telemetry circuitry 116 (e.g., (i) Hardware Guide Scheduler (HGS) (or HGS+) circuitry or (ii) Thread Director circuitry) of processor core 109 to schedule one or more threads for processing in core 109 (e.g., logical core of a plurality of logical cores implemented by core 109). In certain examples, the OS scheduler 162 is to implement one or more scheduling modes (e.g., selects from a plurality of scheduling modes). In certain examples, a scheduling mode causes the scheduling of thread(s) with a dynamic SMT scheduling disclosed herein, for example, to provide SMT core isolation via forced core parking of logical SMT sibling processors when desired (e.g., when necessary), e.g., while allowing a less restrictive (e.g., “small or idle”) scheduling policy for user-initiated background tasks (e.g., compiler/render, etc.) running on the system to take advantage of SMT physical processor cores (e.g., performance cores (P-cores)) (e.g., big cores). In certain examples, an OS 160 includes a control value 164, e.g., to set a number of logical processors that can be in an un-parked (or idle) state at any given time. In certain examples, control value 164 (e.g., “CPMaxCores”) is set (e.g., by a user) to specify the maximum percentage of logical processors (e.g., in terms of logical processors within each Non-Uniform Memory Access (NUMA) node, e.g., as discussed below) that can be in the un-parked state at any given time. In one example (e.g., in a NUMA node) with sixteen logical processors, configuring the value of this setting to 50% ensures that no more than eight logical processors are ever in the un-parked state at the same time. In certain examples, the value of this “CPMaxCores”) setting will automatically be rounded up to a minimum number of cores value (e.g., “CPMinCores”) that specifies the minimum percentage of logical processors (e.g., in terms of all logical processors that are enabled on the system within each NUMA node) that can be placed in the un-parked state at any given time. In one example (e.g., in a NUMA node) with sixteen logical processors, configuring the value of this “CPMinCores” setting to 25% ensures that at least four logical processors are always in the un-parked state. In certain examples, the Core Parking functionality is disabled if the value of this setting is 100%.

In certain examples, non-uniform memory access (NUMA) is a computer system architecture that is used with multiprocessor designs in which some regions of memory have greater access latencies, e.g., due to how the system memory and physical processors (e.g., processor cores) are interconnected. In certain examples, some memory regions are connected directly to one or more physical processors, with all physical processors connected to each other through various types of interconnection fabric. In certain examples, for large multi-processor (e.g., multi-core) systems, this arrangement results in less contention for memory and increased system performance. In certain examples, a NUMA architecture divides memory and processors into groups, called NUMA nodes. In certain examples, from the perspective of any single processor in the system, memory that is in the same NUMA node as that processor is referred to as local, and memory that is contained in another NUMA node is referred to as remote (e.g., where a processor (e.g., core) can access local memory faster).

In certain examples virtual machine monitor (VMM) code 166 is to implement one or more virtual machines (VMs) as an emulation of a computer system. In certain examples, VMs are based on a specific computer architecture and provide the functionality of an underlying physical computer system. Their implementations may involve specialized hardware, firmware, software, or a combination. In certain examples, Virtual Machine Monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM may manage the backend operation of these VMs by allocating the necessary computing, memory, storage and other input/output (I/O) resources, such as, but not limited to, an input/output memory management unit (IOMMU). The VMM may provide a centralized interface for managing the entire operation, status and availability of VMs that are installed over a single host machine or spread across different and interconnected hosts.

As discussed below, depicted core (e.g., branch predictor 120 thereof) includes access to one or more registers. In certain examples, core include one or more general purpose register(s) 108 and/or one more status/control registers 112.

In certain examples, each entry for the branch predictor 120 (e.g., in BTB 124 thereof) includes a tag field and a target field. In one example, the tag field of each entry in the BTB stores at least a portion of an instruction pointer (e.g., memory address) identifying a branch instruction. In one example, the tag field of each entry in the BTB stores an instruction pointer (e.g., memory address) identifying a branch instruction in code. In one example, the target field stores at least a portion of the instruction pointer for the target of the branch instruction identified in the tag field of the same entry. Moreover, in other example, the entries for the branch predictor 120 (e.g., in BTB 124 thereof) includes one or more other fields. In certain examples, an entry does not include a separate field to assist in the prediction of whether the branch instruction is taken, e.g., if a branch instruction is present (e.g., in the BTB), it is considered to be taken.

As shown in FIG. 1, the IP Gen mux 113 of IP generation stage 111 receives an instruction pointer from line 115A. The instruction pointer provided via line 115A is generated by the incrementer circuit 115, which receives a copy of the most recent instruction pointer from the path 113A. The incrementer circuit 115 may increment the present instruction pointer by a predetermined amount, to obtain the next sequential instruction from a program sequence presently being executed by the core.

In one example, upon receipt of the IP from IP Gen mux 113, the branch predictor 120 compares a portion of the IP with the tag field of each entry in the branch predictor 120 (e.g., BTB 124). If no match is found between the IP and the tag fields of the branch predictor 120, the IP Gen mux will proceed to select the next sequential IP as the next instruction to be fetched in this example. Conversely, if a match is detected, the branch predictor 120 reads the valid field of the branch predictor entry which matches with the IP. If the valid field is not set (e.g., has a logical value of 0) the branch predictor 120 considers the respective entry to be “invalid” and will disregard the match between the IP and the tag of the respective entry in this example, e.g., and the branch target of the respective entry will not be forwarded to the IP Gen Mux. On the other hand, if the valid field of the matching entry is set (e.g., has a logical value of 1), the branch predictor 120 proceeds to perform a logical comparison between a predetermined portion of the instruction pointer (IP) and the branch address (BA) field of the matching branch predictor entry in this example. If an “allowable condition” is present, the branch target of the matching entry will be forwarded to the IP Gen mux, and otherwise, the branch predictor 120 disregards the match between the IP and the tag of the branch predictor entry. In some example, the entry indicator is formed from not only the current branch IP, but also at least a portion of the global history.

More specifically, in one example, the BA field indicates where the respective branch instruction is stored within a line of each e memory 132. In certain examples, a processor is able to initiate the execution of multiple instructions per clock cycle, wherein the instructions are not interdependent and do not use the same execution resources.

For example, each line of the instruction each e 132 shown in FIG. 1 includes multiple instructions (e.g., six instructions). Moreover, in response to a fetch operation by the fetch unit 134, the instruction each e 132 responds (e.g., in the case of a “hit”) by providing a full line of each e to the fetch unit 134 in this example. The instructions within a line of each e may be grouped as separate “bundles.” For example, as shown in FIG. 1, the first three instructions in a each e line 133 may be addressed as bundle 0, and the second three instructions may be address as bundle 1. Each of the instructions within a bundle are independent of each other (e.g., can be simultaneously issued for execution). The BA field provided in the branch predictor 120 entries is used to identify the bundle address of the branch instruction which corresponds to the respective entry in certain examples. For example, in one example, the BA identifies whether the branch instruction is stored in the first or second bundle of a particular each e line.

In one example, the branch predictor 120 performs a logical comparison between the BA field of a matching entry and a predetermined portion of the IP to determine if an “allowable condition” is present. For example, in one example, the fifth bit position of the IP (e.g. IP[4]) is compared with the BA field of a matching (e.g., BTB) entry. In one example, an allowable condition is present when IP [4] is not greater than the BA. Such an allowable condition helps prevent the apparent unnecessary prediction of a branch instruction, which may not be executed. That is, when less than all of the IP is considered when doing a comparison against the tags of the branch predictor 120, it is possible to have a match with a tag, which may not be a true match. Nevertheless, a match between the IP and a tag of the branch predictor indicates a particular line of each e, which includes a branch instruction corresponding to the respective branch predictor entry, may about to be executed. Specifically, if the bundle address of the IP is not greater than the BA field of the matching branch predictor entry, then the branch instruction in the respective each e line is soon to be executed. Hence, a performance benefit can be achieved by proceeding to fetch the target of the branch instruction in certain examples.

As discussed above, if an “allowable condition” is present, the branch target of the matching entry will be forwarded to the IP Gen mux in this example. Otherwise, the branch predictor will disregard the match between the IP and the tag. In one example, the branch target forwarded from the branch predictor is initially sent to a Branch Prediction (BP) resteer mux 128, before it is sent to the IP Gen mux. The BP resteer mux 128, as shown in FIG. 1, may also receive instruction pointers from other branch prediction devices. In one example, the input lines received by the BP resteer mux will be prioritized to determine which input line will be allowed to pass through the BP resteer mux onto the IP Gen mux.

In addition to forwarding a branch target to the BP resteer mux, upon detecting a match between the IP and a tag of the branch predictor, the BA of the matching branch predictor entry is forwarded to the Branch Address Calculator (BAC) 142. The BAC 142 is shown in FIG. 1 to be located in the decode stage 140, but may be located in other stage(s). The BAC of may also receive a each e line from the fetch unit 134 via line 137.

The IP selected by the IP Gen mux is also forwarded to the fetch unit 134, via data line 135 in this example. Once the IP is received by the fetch unit 134, the each e line corresponding to the IP is fetched from the instruction each e 132. The each e line received from the instruction each e is forwarded to the BAC, via data line 137.

Upon receipt of the BA in this example, the BAC will read the BA to determine where the pre-selected branch instruction (e.g., identified in the matching branch predictor entry) is located in the next each e line to be received by the BAC (e.g., the first or second bundle of the each e line). In one example, it is predetermined where the branch instruction is located within a bundle of a each e line (e.g., in a bundle of three instructions, the branch instruction will be stored as the second instruction).

In alternative examples, the BA includes additional bits to more specifically identify the address of the branch instruction within a each e line. Therefore, the branch instruction would not be limited to a specific instruction position within a bundle.

After the BAC determines the address of the pre-selected branch instruction within the each e line, and has received the respective each e line from the fetch unit 134, the BAC will decode the respective instruction to verify the IP truly corresponds to a branch instruction. If the instruction addressed by BA in the received each e line is a branch instruction, no correction for the branch prediction is necessary. Conversely, if the respective instruction in the each e line is not a branch instruction (i.e., the IP does not correspond to a branch instruction), the BAC will send a message to the branch predictor to invalidate the respective branch predictor entry, to prevent similar mispredictions on the same branch predictor entry. Thereafter, the invalidated branch predictor entry will be overwritten by a new branch predictor entry.

In addition, in one example, the BAC will increment the IP by a predetermined amount and forward the incremented IP to the BP resteer mux 128, via data line 145, e.g., the data line 145 coming from the BAC will take priority over the data line from the branch predictor. As a result, the incremented IP will be forwarded to the IP Gen mux and passed to the fetch unit in order to correct the branch misprediction by fetching the instructions that sequentially follow the IP.

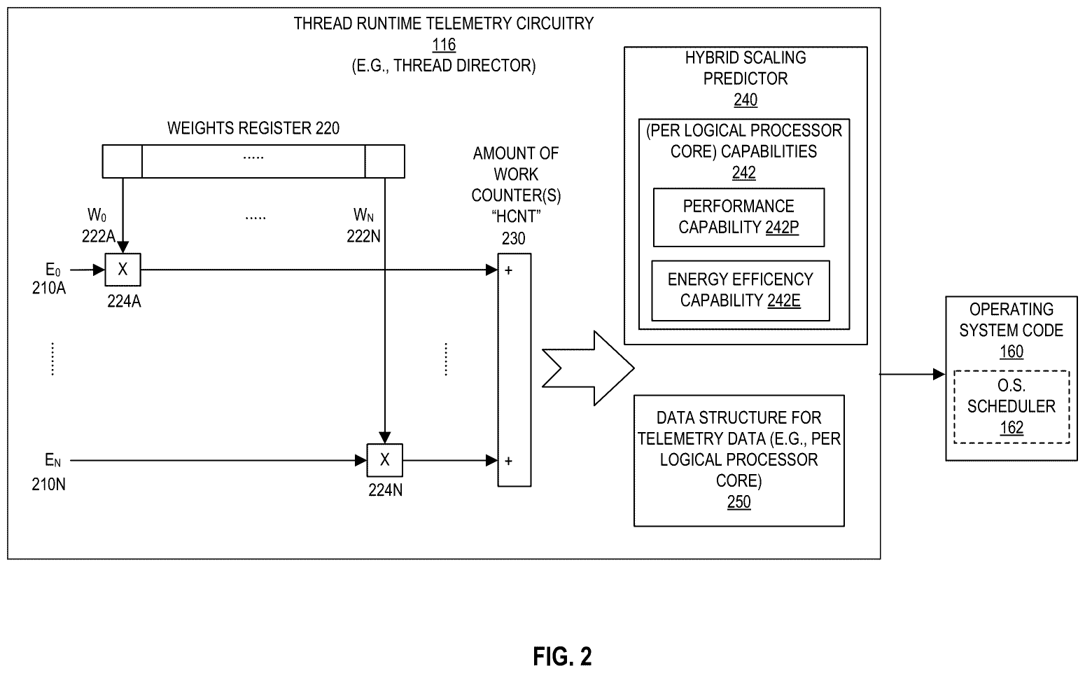

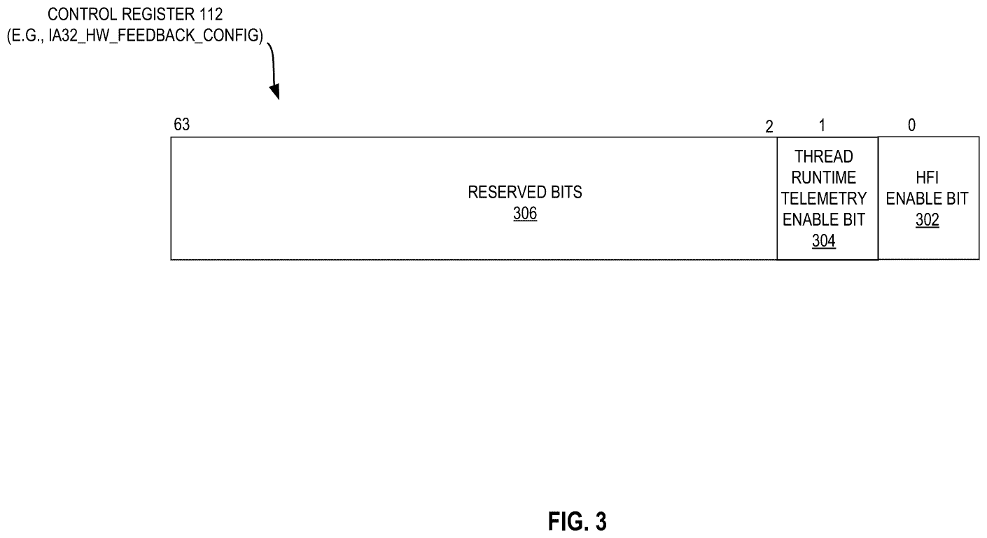

In certain examples, the context manager circuit 110 allows one or more of the above discussed shared components to be utilized by multiple contexts, e.g., while alleviating information being leaked across contexts by directly or indirectly observing the information stored. Computing system 100 (e.g., core 109) may include a control register (e.g., model specific register(s)) 112 (e.g., as discussed below in reference to FIG. 3)), a segment register 114 (e.g., indicating the current privilege level), a thread runtime telemetry circuitry 116 (e.g., as discussed below in reference to FIGS. 2-6), or any combination thereof. Segment register 114 may store a value indicating a current privilege level of software operating on a logical core, e.g., separately for each logical core. In one example, current privilege level is stored in a current privilege level (CPL) field of a code segment selector register of segment register 114. In certain examples, processor core 109 requires a certain level of privilege to perform certain actions, for example, actions requested by a particular logical core (e.g., actions requested by software running on that particular logical core).

Each thread may have a context. In certain examples, contexts are identified by one or more of the following properties: 1) a hardware thread identifier such as a value that identifies one of multiple logical processors (e.g., logical cores) implemented on the same physical core through techniques such as simultaneous multi-threading (SMT); 2) a privilege level such as implemented by rings; 3) page table base address or code segment configuration such as implemented in a control register (e.g., CR3) or code segment (CS) register; 4) address space identifiers (ASIDs) such as implemented by Process Context ID (PCID) or Virtual Process ID (VPID) that semantically differentiate the virtual-to-physical mappings in use by the CPU; 5) key registers that contain cryptographically sealed assets (e.g., tokens) used for determination of privilege of the executing software; and/or 6) ephemeral—a context change such as a random reset of context.

Over any non-trivial period of time, many threads (e.g., contexts thereof) may be active within a physical core. In certain examples, system software time-slices between applications and system software functions, potentially allowing many contexts access to microarchitectural prediction and/or each ing mechanisms.

An instance of a thread runtime telemetry circuitry 116 (e.g., (i) Hardware Guide Scheduler (HGS) (or HGS+) circuitry or (ii) Thread Director circuitry) may be in each core 109(1-N) of computer system 100 (e.g., for each logical processor implemented by a core). A single instance of a thread runtime telemetry circuitry 116 may be anywhere in computer system 100. e.g., a single instance of thread runtime telemetry circuitry used for all cores 109(1-N) present.

In one example, status/control registers 112 include status register(s) to indicate a status of the processor core and/or control register(s) to control functionality of the processor core. In one example, one or more (e.g., control) registers are (e.g., only) written to at the request of the OS running on the processor, e.g., where the OS operates in privileged (e.g., system) mode, but not for code running in non-privileged (e.g., user) mode. In one example, a control register can only be written to by software running in supervisor mode, and not by software running in user mode. In certain examples, control register 112 includes a field to enable the thread runtime telemetry circuitry 116, e.g., as shown in FIG. 3.

In certain examples, decoder 146 decodes an instruction, and that decoded instruction is executed by the execution circuit 154, for example, to perform operations according to the opcode of the instruction.

In certain examples, decoder 146 decodes an instruction, and that decoded instruction is executed by the execution circuit 154, for example, to reset one or more capabilities (or one more software thread runtime property histories), e.g., of thread runtime telemetry circuitry 116.

Computer system 100 may include performance monitoring circuitry 172, e.g., including any number of performance counters therein to count, monitor, and/or or log events, activity, and/or other measure related to performance. In various examples, performance counters may be programmed by software running on a core to log performance monitoring information. For example, any of performance counters may be programmed to increment for each occurrence of a selected event, or to increment for each clock cycle during a selected event. The events may include any of a variety of events related to execution of program code on a core, such as branch mispredictions, each e hits, each e misses, translation lookaside buffer hits, translation lookaside buffer misses, etc. Therefore, performance counters may be used in efforts to tune or profile program code to improve or optimize performance. In certain examples, thread runtime telemetry circuitry 116 is part of performance monitoring circuitry 172. In certain examples, thread runtime telemetry circuitry 116 is separate from performance monitoring circuitry 172.

In certain examples, thread runtime telemetry circuitry 116 (e.g., (i) Hardware Guide Scheduler (HGS) (or HGS+) circuitry or (ii) Thread Director circuitry) is to generate “capability” values to differentiate logical processors (e.g., CPUs) of each physical processor core 109 with different (e.g., current) computing capability (e.g., computing throughput). In certain examples, the thread runtime telemetry circuitry 116 generates capability values that are normalized in a (e.g., 256, 512, 1024, etc.) range. In certain examples, the thread runtime telemetry circuitry 116 is able to estimate how busy and/or energy efficient a logical processor (e.g., CPU) is (e.g., on a per class basis) via the capability values, e.g., and an OS scheduler 162 is to utilize the capability values when evaluating performance versus energy trade-offs for scheduling threads.

In certain examples, the performance (Perf) capability value of a logical processor (e.g., CPU) represents the amount of work it can absorb when running at its highest frequency, e.g., compared to the most capable logical processor (e.g., CPU) of the system 100. In certain examples, the performance (Perf) capability value for a single logical processor (e.g., CPU) of the system 100 is a value (e.g., an 8-bit value indicating values of 0 to 255) that specifies the relative performance level of the logical processor, e.g., where higher values indicate higher performance and/or the lowest performance level of 0 indicates a recommendation to the OS to not schedule any threads on it for performance reasons.

In certain examples, the energy efficiency (EE) capability value of a logical processor (e.g., CPU) of the system 100 represents its energy efficiency (e.g., in performing processing). In certain examples, the energy efficiency (EE) capability value of a single logical processor (e.g., CPU) is a value (e.g., an 8-bit value indicating values of 0 to 255) that specifies the relative energy efficiency level of the logical processor, e.g., where higher values indicate higher energy efficiency and/or the lowest energy efficiency capability of 0 indicates a recommendation to the OS to not schedule any software threads on it for efficiency reasons. In certain examples, an energy efficiency capability of the maximum value (e.g., 255) indicates which logical processors have the highest relative energy efficiency capability. In certain examples, the maximum value (e.g., 255) is an explicit recommendation for the OS to consolidate work on those logical processors for energy efficiency reasons.

In certain examples, the functionality discussed herein (e.g., the core isolation via the parking of one or more SMT sibling logical core) is implemented by using thread runtime telemetry circuitry 116 (e.g., Intel® Thread Director circuitry, e.g., microcontroller) to dynamically park an SMT core's logical core sibling(s) (e.g., when concurrent scenarios are executed). In certain examples, a processor (e.g., via non-transitory machine-readable medium that stores power management code (e.g., p-code)) determines, using per energy performance preference (EPP) group utilization and quality of service (QOS), if there is limited threaded high QoS and/or low EPP activity (e.g., foreground threads) and multi-threaded low QoS and/or high EPP activity (e.g., background threads). In certain examples, if so, then the processor (e.g., via non-transitory machine-readable medium that stores power management code (e.g., p-code)) will populate a data structure that stores telemetry data (e.g., per logical processor core) of the thread runtime telemetry circuitry 116 to cause the dynamic parking of an SMT core's logical core sibling(s). In certain examples, such a data structure stores data of (i) Hardware Guide Scheduler (HGS) (or HGS+) circuitry or (ii) Thread Director circuitry. In certain examples, the thread runtime telemetry circuitry 116 is to cause a write of a (e.g., capability) value (e.g., zero or about zero) to the entry or entries of the sibling logical processor core(s) of a logical processor core of an SMT physical processor core to hint to the OS 160 (e.g., to the OS scheduler 162) to avoid using those sibling logical processor core(s), e.g., to avoid scheduling a thread on those sibling logical processor core(s).

In certain examples, the thread runtime telemetry circuitry 116 (e.g., (i) Hardware Guide Scheduler (HGS) (or HGS+) circuitry or (ii) Thread Director circuitry) (e.g., via its corresponding data structure) communicates numeric performance and numeric power efficiency capabilities of each logical core in a certain (e.g., 0 to 255) (e.g., 0 to 511) (e.g., 0 to 1023) range to the OS in real-time. In certain examples, when either the performance or energy capabilities efficiency of a logical processor core (e.g., CPU) is zero, the thread runtime telemetry circuitry 116 adapts to the current instruction mix and recommends not scheduling any tasks on such logical core.

In certain examples, thread runtime telemetry circuitry 116 predicts capability values based on the dynamic characteristics of a system (e.g., eliminating a need to run a workload on each core to measure its amount of work), for example, by providing ISA-level counters (e.g., number of load instructions) that may be shared among various cores, and lowering the hardware implementation costs of performance monitoring by providing a single counter based on multiple performance monitoring events.

Each core 109 of computer system 100 may be the same (e.g., symmetric cores) or a proper subset of one or more of the cores may be different than the other cores (e.g., asymmetric cores). In one example, a set of asymmetric cores includes a first type of core (e.g., a lower power core) and a second, higher performance type of core (e.g., a higher power core). In certain examples, an asymmetric processor is a hybrid processor that includes one or more less powerful non-SMT physical processor cores (e.g., efficient cores (E-cores)) (e.g., small cores) and one or more SMT physical processor cores (e.g., performance cores (P-cores)) (e.g., big cores).

In certain examples, a computer system includes multiple cores that all execute a same instruction set architecture (ISA). In certain examples, a computer system includes multiple cores, each having an instruction set architecture (ISA) according to which it executes instructions issued or provided to it and/or the system by software. In this specification, the use of the term “instruction” may generally refer to this type of instruction (which may also be called a macro-instruction or an ISA-level instruction), as opposed to: (1) a micro-instruction or micro-operation that may be provided to execution and/or scheduling hardware as a result of the decoding (e.g., by a hardware instruction-decoder) of a macro-instruction, and/or (2) a command, procedure, routine, subroutine, or other software construct, the execution and/or performance of which involves the execution of multiple ISA-level instructions.

In some such systems, the system may be heterogeneous because it includes cores that have different ISAs. A system may include a first core with hardware, hardwiring, microcode, control logic, and/or other micro-architecture designed to execute particular instructions according to a particular ISA (or extensions to or other subset of an ISA), and the system may also include a second core without such micro-architecture. In other words, the first core may be capable of executing those particular instructions without any translation, emulation, or other conversion of the instructions (except the decoding of macro-instructions into micro-instructions and/or micro-operations), whereas the second core is not. In that case, that particular ISA (or extensions to or subset of an ISA) may be referred to as supported (or natively supported) by the first core and unsupported by the second core, and/or the system may be referred to as having a heterogeneous ISA.

In other such systems, the system may be heterogeneous because it includes cores having the same ISA but differing in terms of performance, power consumption, and/or some other processing metric or capability. The differences may be provided by the size, speed, and/or microarchitecture of the core and/or its features. In a heterogeneous system, one or more cores may be referred to as “big” because they are capable of providing, they may be used to provide, and/or their use may provide and/or result in a greater level of performance (e.g., greater instructions per cycle (IPC)), power consumption (e.g., less energy efficient), and/or some other metric than one or more other “small” or “little” cores in the system.

In these and/or other heterogeneous systems, it may be possible for a task to be performed by different types of cores. Furthermore, it may be possible for a scheduler (e.g., a hardware scheduler and/or a software scheduler 162 of an operating system 160 executing on the processor) to schedule or dispatch tasks to different cores and/or migrate tasks between/among different cores (generally, a “task scheduler”). Therefore, efforts to optimize, balance, or otherwise affect throughput, wait time, response time, latency, fairness, quality of service, performance, power consumption, and/or some other measure on a heterogeneous system may include task scheduling decisions.

For example, if a particular task is mostly stalled due to long latency memory accesses, it may be more efficient to schedule it on a “small” core (e.g., E-core) and save power of an otherwise bigger core (e.g., P-core). On the other hand, heavy tasks may be scheduled on a big core (e.g., P-core) to complete the compute sooner, e.g., and let the system go into sleep/idle sooner. Due to the diversity of workloads a system (e.g., a client) can perform, the dynamic characteristics of a workload, and conditions of the system itself, it might not be straightforward for a pure software solution to make such decisions. Therefore, the use of examples herein (e.g., of a thread runtime telemetry circuitry) may be desired to provide information upon which such decisions may be based, in part or in full. Furthermore, the use of these examples may be desired in efforts to optimize and/or tune applications based on the information that may be provided.

A processor may include a thread runtime telemetry circuitry 116 that is shared by multiple contexts (and/or cores), e.g., as discussed further below in reference to FIGS. 2-6. A processor may contain other shared structures dealing with state including, for example, prediction structures, each ing structures, a physical register file (renamed state), and buffered state (a store buffer). Prediction structures, such as branch predictors or prefetchers, may store state about past execution behavior that is used to predict future behavior. A processor may use these predictions to guide speculation execution, achieving performance that would not be possible otherwise. Caching structures, such as each es or TLBs, may keep local copies of shared state so as to make accesses by the processor (e.g., very) fast.

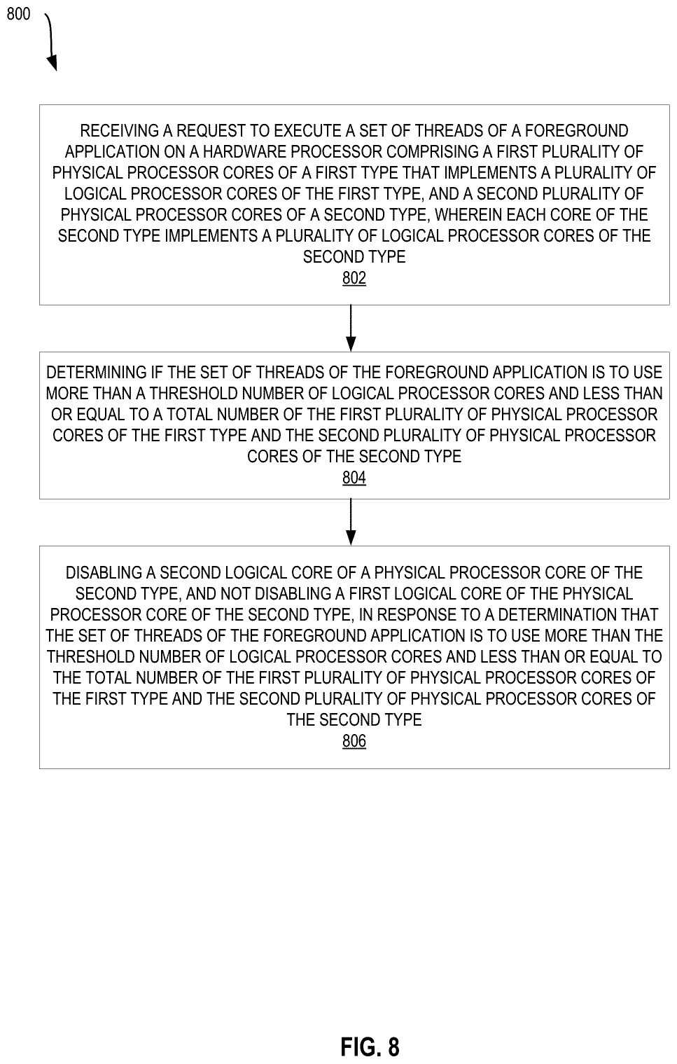

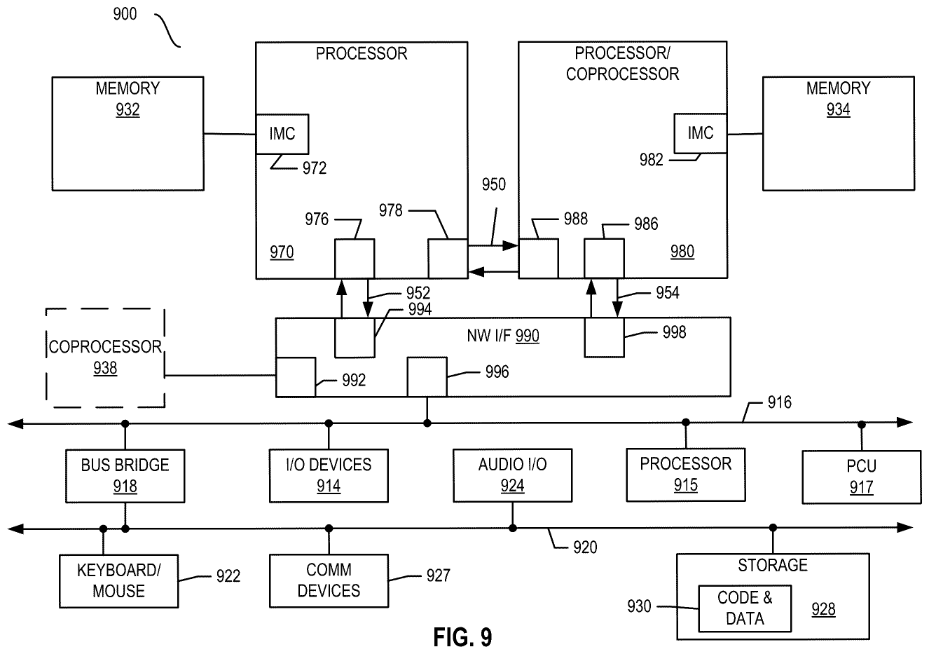

FIG. 2 illustrates thread runtime telemetry circuitry 116 according to examples of the disclosure. Thread runtime telemetry circuitry 116 (and/or hybrid scaling predictor 240) may be implemented in logic gates and/or any other type of circuitry, all or parts of which may be included in a discrete component (e.g., microcontroller) and/or integrated into the circuitry of a processing device or any other apparatus in a computer or other information processing system, for example, implemented in a core (such as core 109 in FIG. 1) and/or a system agent (such as system agent 1010 in FIG. 10) in a heterogeneous SoC, (such as a heterogeneous instance of SoC 900 in FIG. 9).

In certain examples, thread runtime telemetry circuitry 116 generates one or more software thread runtime property histories (e.g., including the weight values and/or HCNT counter values discussed herein). In FIG. 2, each of any number of unweighted event counts (shown as E0 210A to EN 210N) represents an unweighted event count or any other output of a performance counter (generally, each an “unweighted event count”), such as any performance counters in performance monitoring circuitry 172 and/or thread runtime telemetry circuitry 116 of FIG. 1. In various examples, E0 210A to EN 210N may represent a set of any number of unweighted event counts including any number of subsets of unweighted event counts from different (e.g., logical) cores. For example, the unweighted event counts may be from performance counters all in one (e.g., logical) core, from one or more performance counters in a first (e.g., logical) core plus one or more performance counters in a second (e.g., logical) core, from one or more performance counters in a first (e.g., logical) core plus one or more performance counters in a second (e.g., logical) core plus one or more performance counters in a third (e.g., logical) core, and so on. Furthermore, any one of more of the event counts (e.g., E0 210A to EN 210N) may represent an output of (e.g., feedback from) an active runtime (e.g., work) counter, such as work counter 230 (as described below), as in an example in which a hierarchical arrangement of performance and work counters is implemented (note that in such an example, an event count may be referred to as an unweighted event count, even though it may have been generated by a work counter based on weighted event counts).

In FIG. 2, weights register 220 represents a programmable or configurable register or other storage location (or combination of storage locations), to store any number of weight values (shown as w0 222A to wN 222N), each weight value corresponding to one of the unweighted event counts and to be used by a corresponding weighting unit (shown as weighting units 224A to 224N) to weight the corresponding unweighted event count and generate a weighted event count. The weight values may be a tuned set of values. For example, software or firmware may assign a weight value of 1 to E0 and a weight value of 2 to EN, in which case weighting unit 224A may weight (e.g., scale or multiply) E0 by a factor of 1 and weighting unit 224N may weight (e.g., scale or multiply) EN by a factor of 2. In various examples, any weight values (including 0), range of weight values, and/or weighting approach (e.g., multiplying, dividing, adding, etc.) may be used. In various examples, implementations of a weights register and/or weighting units may limit the choice of weight values to one of a number of possible weight values.

In FIG. 2, weighted event counts (shown as the outputs of weighting units 224A to 224N) are received for processing by a work counter (shown as heterogenous (e.g., hybrid) counter (HCNT) 230, but may be used for homogenous or heterogenous processors/systems). In an example, the processing of weighted event counts may include summing the weighted event counts to generate a measure of an amount of work (generally, a “measured work amount”). Various examples may provide for this measured work amount to be based on a variety of performance measurements or other parameters, each scaled or manipulated in a variety of ways, and to be used for a variety of purposes. In an example, a work counter may be used to provide a dynamic profile of the current workload.

For example, HCNT 230 may be used to generate a weighted sum of various classes of performance monitoring events that can be dynamically estimated by all cores in a system (e.g., SoC). HCNT 230 may be used to predict a thread runtime telemetry circuitry (e.g., HGS or Thread Director) class, e.g., HCNT 230 may be used as a source for hybrid scaling predictor 240 and/or for any software having access to HCNT 230. The events may be sub-classes of an ISA (e.g., AVX floating-point, AVX2 integer), special instructions (e.g., repeat string), or categories of bottlenecks (e.g., front-end bound from top-down analysis). The weights may be chosen to reflect a type of execution code (e.g., memory stalls or branching code) and/or a performance ratio (e.g., 2 for an instruction class that executes twice as fast on a big core and 1 for all other instruction classes), a scalar of amount of work (e.g., 2 for fused-multiply instructions), etc.

Certain examples provide for any of a variety of events to be counted and/or summed, including events related to arithmetic floating-point (e.g., 128-bit) vector instructions, arithmetic integer (e.g., 256-bit) vector instructions, arithmetic integer vector neural network instructions, load instructions, store instructions, repeat strings, top-down micro-architectural analysis (TMA) level 1 metrics (e.g., front-end bound, back-end bound, bad speculation, retiring), and/or any performance monitoring event counted by any counter.

In addition to a work counter according to an example of the disclosure, FIG. 2 illustrates a representation of usages of a work counter according to examples of the disclosure, including use by a hybrid scaling predictor 240 and/or by any software (e.g., OS code 160) having access to the work counter. In an example, hybrid scaling predictor 240 (e.g., implemented in hardware or firmware) provides information (for example, direct or indirect information, e.g., by enabling range of indexes based on the counter values) to an OS 160, and/or may be used to predict performance scaling (e.g., between big cores (e.g., P-cores) and little cores (e.g., E-cores)), e.g., by providing a hint based on the history to the hardware (e.g., via writing to data structure 250 that is read by the OS).

In certain examples, hybrid scaling predictor 240 is to generate one or more capability values 242 (e.g., per logical processor core). In certain examples, the capability values 242 include a performance capability 242P (e.g., per logical processor core) and/or an energy efficiency capability 242E (e.g., per logical processor core).

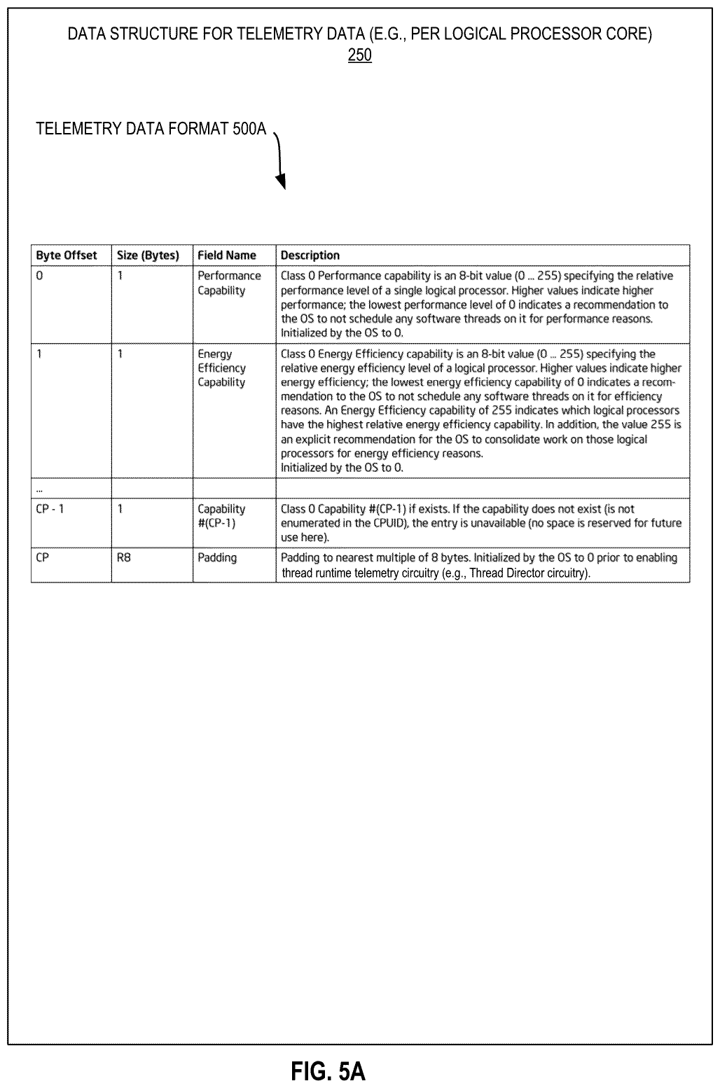

In certain examples, the data generated by thread runtime telemetry circuitry 116 is stored in data structure 250, e.g., with one or more sets of entries for each logical processor core. In certain examples, the data structure is (e.g., a table) according to the example format in FIGS. 5A-5B. In certain examples, the data structure 250 (e.g., accessible by OS code 160 or at least OS scheduler 162 thereof) is stored in storage of the thread runtime telemetry circuitry 116 (e.g., within thread runtime telemetry circuitry 116 or separate from the thread runtime telemetry circuitry 116, e.g., in system memory 102 of the system 100). In certain examples, the data in this data structure 250 is modifiable (e.g., by thread runtime telemetry circuitry 116) to implement core isolation via forced core parking of logical SMT sibling processors when desired.

In an example, a work counter may be used to provide hints (e.g., capability values) (e.g., written into data structure 250) to an operating system running on a heterogeneous (e.g., or homogenous) SoC or system, where the hints may provide for task scheduling that may improve performance and/or quality of service. For example, a homogeneous system including one or more instances of the same core for use in optimal multicore thread scheduling. For example, a heterogeneous client system including one or more big cores (e.g., P-cores) and one more little cores (e.g., E-cores) may be used to run an artificial intelligence (AI) application (e.g., a machine learning model) including a particular class of instructions that may speed up processing of the type of instructions typically used in the AI application, e.g., particularly or only if executed on a big core (e.g., P-core). The use of a work counter programmed to monitor execution of this class of instruction may provide hints to an OS 160 to guide the OS scheduler 162 to schedule threads including these instructions on big cores (e.g., P-cores) instead of little cores (e.g., E-cores), thereby improving performance and/or quality of service.

In certain examples, the weight values in register 220 are programmable to provide for tuning of the weights (e.g., in a lab) based on actual results. In examples, one or more weights of zero may be used to disconnect a particular event or class of events. In examples, one of more weights of zero may be used for isolating various components that feed into a work counter. Examples herein may support an option for hardware and/or software (e.g., an OS) to enable/disable a work counter for any of a variety of reasons, for example, to avoid power leakage when the work counter is not in use.

In one example, scheduler 162 of operating system code 160 in FIG. 1 uses thread runtime telemetry circuitry 116 (and/or hybrid scaling predictor 240) to select the best core (e.g., type) (or other component) to be used to execute a thread for a software thread, e.g., a software thread of first application code (e.g., first application code 168 in FIG. 1) or second application code (e.g., second application code 170 in FIG. 1). In certain examples, scheduler 162 of operating system code 160 in FIG. 1 uses the capability values 242 (e.g., a performance capability 242P per logical processor core) and/or an energy efficiency capability 242E per logical processor core) (e.g., stored in data structure 250) are used to implement dynamic SMT scheduling disclosed herein, for example, to provide core isolation via forced core parking of logical SMT sibling processors when desired (e.g., when necessary), e.g., while allowing a less restrictive (e.g., “small or idle”) scheduling policy for user-initiated background tasks (e.g., compiler/render, etc.) running on the system to take advantage of SMT physical processor cores (e.g., performance cores (P-cores)) (e.g., big cores).

In certain examples, software thread runtime property histories (e.g., including the weight values and/or HCNT counter values discussed herein) of thread runtime telemetry circuitry 116 may be useful for a first software thread but not for a following second software thread. In other examples, it may be desirable to clear (e.g., to set to zero) certain software thread runtime property histories (e.g., capability values), e.g., to provide core isolation via forced core parking of logical SMT sibling processors when desired.

Thus, certain examples herein provide an instruction (and method) to clear the software thread runtime property histories, for example, to clear the capability values of a certain logical processor (e.g., and not other logical processor(s)), e.g., to provide core isolation via forced core parking of logical SMT sibling processors. For example, clearing the HCNT counter current value (e.g., and thus the impact of this value of the full prediction flow). For example, clearing the current values of the counters E0 . . . En and/or HCNT 230 in FIG. 2.

In one example, the instruction mnemonic is “HRESET” but for other examples, it can be another mnemonic. The usage opcode of HRESET can include an immediate operand, other types of operands, or zero explicit operands (e.g., defined without use of any operand). In one example, the hardware (e.g., processor core) ignores any immediate operand value (e.g., without causing an exception (e.g., fault)) and/or any request specific setting. It should be understood that other examples may utilize an immediate operand value (e.g., such that is reserved for other uses). In another example where the instruction includes an immediate operand, it is possible to define that this immediate operand will include only zero (e.g., or cause an exception (e.g., fault) otherwise when executing the instruction). Other operand values may not be supported, and an incorrect setting can generate an exception like Invalid Opcode (e.g., UnDefined Opcode or General Protection Fault).

In one example, an instruction is to ignore an explicit (e.g., immediate) operand, while its implicit operand (e.g., not explicitly specified in a field of the instruction) may be a general purpose register (e.g., EAX register) (e.g., of general purpose registers 108 in FIG. 1) (e.g., to enable 32 options of bit mask configuration). Other Another option is to define the instruction without an explicit immediate operand and in this case a valid use may be indicated by the opcode (e.g., corresponding to the mnemonic of HRESET), for example, while its implicit operand (e.g., not explicitly specified in a field of the instruction) may be a general purpose register (e.g., EAX register) (e.g., of general purpose registers 108 in FIG. 1). In certain examples, the implicit operand is a single register (e.g., EAX) or a concatenation of a plurality of registers (e.g., EAX: EDX is to concatenate the contents of register EAX followed by the contents of register EDX (e.g., to enable 64 options of bit mask configuration)).

In certain examples, an instruction utilizes a new opcode (e.g., not a legacy opcode of a legacy instruction), for example, such that hardware that does not support this instruction will not be able to execute it (e.g., and the exception undefined instruction will be happened in happen in a case like this). In certain examples, use of this instruction may include that software (e.g., an OS) is to check if the hardware supports execution of this instruction before scheduling execution of the instruction. In one example, the software is to check if the hardware supports execution of the instruction be executing a check (e.g., having a mnemonic of CPUID) instruction feature bit setting.

In certain examples, execution of the instruction is only allowed for a certain privilege level (for example, supervisor level (e.g., ring 0) and/or user level (e.g., ring 3)). In an example where the instruction is limited only to be used by supervisor level (e.g., an OS) (e.g., in ring 0 only), request for execution of the instruction for user level (e.g., a user application) generates an exception, e.g., a general-protection exception.

Certain examples herein define an instruction where the OS is able to select the components of the processor to be cleared (e.g., to (e.g., only) clear one or more logical processor's histories) (e.g., to (e.g., only) clear one or more of software thread runtime property histories). In one example, the instruction includes a control parameter to enable software (e.g., the OS) to control in runtime the exact history reset supported (e.g., in a much faster method over writing into an MSR). In certain examples, the control of the instruction is done by the instruction's parameters (e.g., a data register that enables 32-bit control options and/or a set of data registers that enables 64-bit control options). In certain examples, an instruction also defines OS control (e.g., opt-in) on the support capabilities of the instruction. In certain examples, an instruction takes an implicit operand (e.g., EAX) or an explicit operand.

In an example where the instruction is supported in user mode (e.g., ring 3), the OS may have the ability to control and opt-in what capabilities (e.g., of a plurality of capabilities) that the instruction include and/or what type of history this instruction can reset and in which way. In order to support this, in certain examples an OS assist (e.g., an OS system call of an application programming interface (API)) can be requested, and used to enable the instruction for user level code, indicate which reset (e.g., HRESET) support capabilities were enabled by the OS (e.g., and supported by the hardware), and/or used to control any reset (e.g., HRESET) instruction parameters (e.g., in supervisor level).

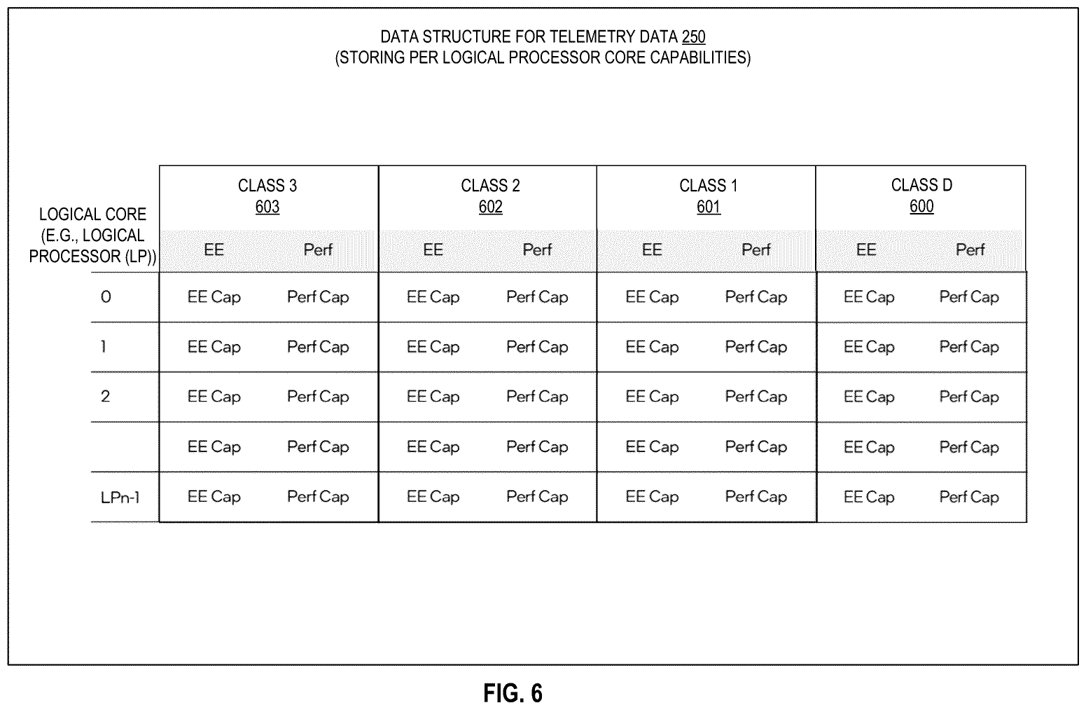

In one example, an OS sets this instruction as part of an OS scheduler runtime support, for example, to clear the capability values of a certain logical processor (e.g., and not other logical processor(s)) to provide core isolation via forced core parking of logical SMT sibling processors (e.g., as shown in FIG. 7). In certain examples, the instruction is defined with a new opcode so the software (e.g., OS) is to first check if the hardware supports this instruction and what are the capabilities of it before this instruction is able to be used. Thus, in one example, a different code path is defined by the software to support this instruction. For example, with the checking if the hardware supports the instruction performed by reading (e.g., CPUID) feature bit(s) to determine if the hardware supports this instruction. In one example, the software is to use this instruction only if the hardware supports it as indicated by its enumeration method.

In one example of a processor, execution is done in a speculative way. In order to avoid speculative history reset, it is possible that while the (e.g., HRESET) instruction is executed for a history reset (e.g., while all the checks to reset the history have happened, but before the history reset itself has happened), it will take an action as a pre serialized pre-serialized action instruction, e.g., where all prior (in program order) instructions have completed locally before the history reset is done. In one example, HRESET is used to avoid a history leak, e.g., in a core that executes instructions out of program order. Another possible support option is to enable pre-serialization instruction to support only on a subset of the history reset types that can be affected from the processor speculative execution method. In yet other another option, the instruction is supported as a serialized. It is also possible to define the support as a serialized instruction only for specific HRESET capabilities and only when these HRESET capabilities are enabled to be in use. For example, options to select a pre-serialized instruction support method or a serialized instruction support method for a proper subset of history reset types may be used to limit any negative performance side effect of the pre-serialized or the serialized instruction support, e.g., where all prior (e.g., in program order) instructions have completed locally before the history reset is performed.

In one example, a reset (e.g., HRESET) instruction includes a control register (e.g., that the OS uses) in order to enable the different support features. In one example, as a default, all of the support features be disabled. In one example, the OS is to enable a subset or all of the support features. In one example, only the lower (e.g., 32) proper subset of bits are allocated for HRESET usage.

In certain examples, thread runtime telemetry circuitry 116 is enabled by a control register 112. An example format of this register is show in FIG. 3.

FIG. 3 illustrates an example format of a control register 112 to enable thread runtime telemetry according to some examples. Format of control register 112 (e.g., IA32_HW_FEEDBACK_CONFIG) for a logical processor core may include bit indices [63:2] 306 as reserved, bit index one (bit position two) 304 to turn on thread runtime telemetry (e.g., the corresponding functionality of thread runtime telemetry circuitry 116), and/or bit index zero (bit position one) 302 to turn on hardware feedback interface (HFI) (e.g., the corresponding functionality of performance monitoring circuitry 172). In certain examples, both bits 0 and 1 must be set for thread runtime telemetry circuitry 116 (e.g., Thread Director circuitry) to be enabled. In certain examples, the (e.g., extra) “class” columns in the run time telemetry (e.g., Thread Director) data structure 250 (e.g., table) are updated by hardware immediately following setting those two bits. In one example, the control register 112 (e.g., bits 0 302 and/or 1 304) thereof is only set (or reset) for a request made in supervisor mode.

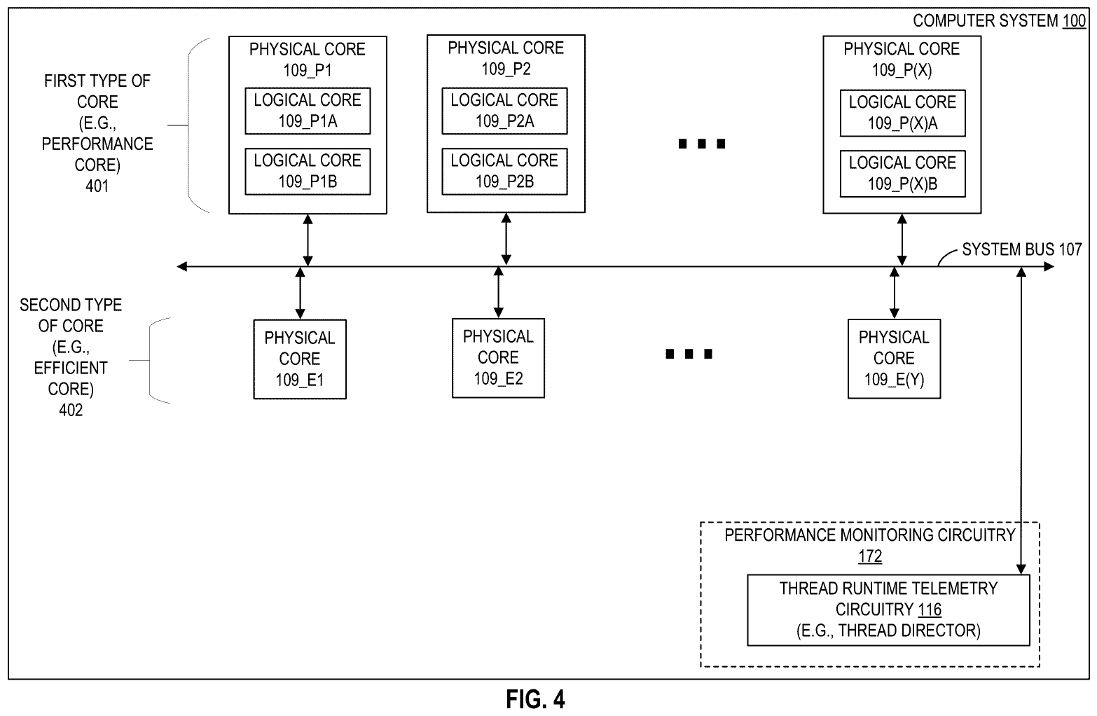

FIG. 4 illustrates a computer system 100 including a first plurality of physical processor cores of a first type 401 and a second plurality of physical processor cores of a second type 402, where each core of the first type is to implement a plurality of logical processor cores according to some examples. In certain examples, the first type of core 401 is a SMT physical processor core (e.g., performance core (P-core)) (e.g., big core). In certain examples, the second type of core 402 is a less powerful non-SMT physical processor core (e.g., efficient core (E-core)) (e.g., small core).

In certain examples, a computer system 100 includes a plurality of SMT types of physical cores of the first physical core type 401, e.g., “X” number of physical cores 401 where X is an integer greater than one. In certain examples, each SMT type of first physical core 401 implements a plurality of logical cores, e.g., an operating system (and application) views each logical core as if it is its own discrete core even where two logical cores are implemented by the same physical core. In FIG. 4, (e.g., performance) physical core 109P-1 implements logical core 109P-1A and logical core 109P-1B, (e.g., performance) physical core 109P-2 implements logical core 109P-2A and logical core 109P-2B, (e.g., performance) physical core 109P(X) implements logical core 109P(X)A and logical core 109P(X)B, etc.

In certain examples, a computer system 100 includes a plurality of non-SMT types (or in other examples, SMT types) of physical cores of the second physical core type 402, e.g., “Y” number of physical cores 402 where Y is an integer greater than one (e.g., where X and Y are equal in some examples and not equal in other examples). In certain examples, each non-SMT type of second physical core 402 implements only a single logical core. In FIG. 4. (e.g., energy efficiency) physical core 109E-1 implements a single logical core, (e.g., energy efficiency) physical core 109E-2 implements a single logical core, physical core 109E(Y) implements a single logical core, etc. In one example, computer system 100 includes six SMT physical processor cores of the first type 401 (e.g., 12 logical processor cores) and eight non-SMT physical processor cores of the second type 402, so 14 (6+8) physical processor cores but 20 (12+8) logical processor cores total for such a computer system 100.

In certain examples, thread runtime telemetry circuitry 116 (e.g., Thread Director circuitry) is to generate runtime telemetry data for the computer system 100 in FIG. 4, e.g., including one or more capability values generated for each logical core. In certain examples, performance monitoring circuitry 172 is to generate performance data for the computer system 100 in FIG. 4, e.g., not including one or more capability values for each logical core.

FIGS. 5A-5B illustrate an example format 500A-500B for telemetry data (e.g., per logical processor core) according to some examples. In certain examples, telemetry data according to format 500A-500B is generated by thread runtime telemetry circuitry 116 (e.g., Thread Director circuitry). In certain examples, telemetry data is stored in run time telemetry (e.g., Thread Director) data structure 250 (e.g., table). In certain examples, upper case CL is a class and upper case CP is a capability defined for the processor. In certain examples, a first capability is a performance capability, and a second capability is an energy efficiency capability. In certain examples, the various classes (CL) indicate (e.g., performance) differences between the cores (e.g., different core functionality), e.g., classes where certain cores (e.g., P-cores) offer higher performance than other cores (e.g., E-cores). For example, where a first class (e.g., class 1) indicates support for an ISA extension such as, but not limited to, vector extensions (e.g., AVX) (e.g., AVX2-FP32), matrix extensions (e.g., AMX), etc., and Class 2 indicates higher Vector Neural Network Instructions (VNNI) (e.g., AVX512 VNNI) performance differences. Certain examples include a class to track waits (e.g., UMWAIT/TPAUSE/PAUSE, etc.) to prevent Performance-cores (e.g., P-cores) from sitting idle while real work goes to the Efficient-cores (e.g., E-cores).

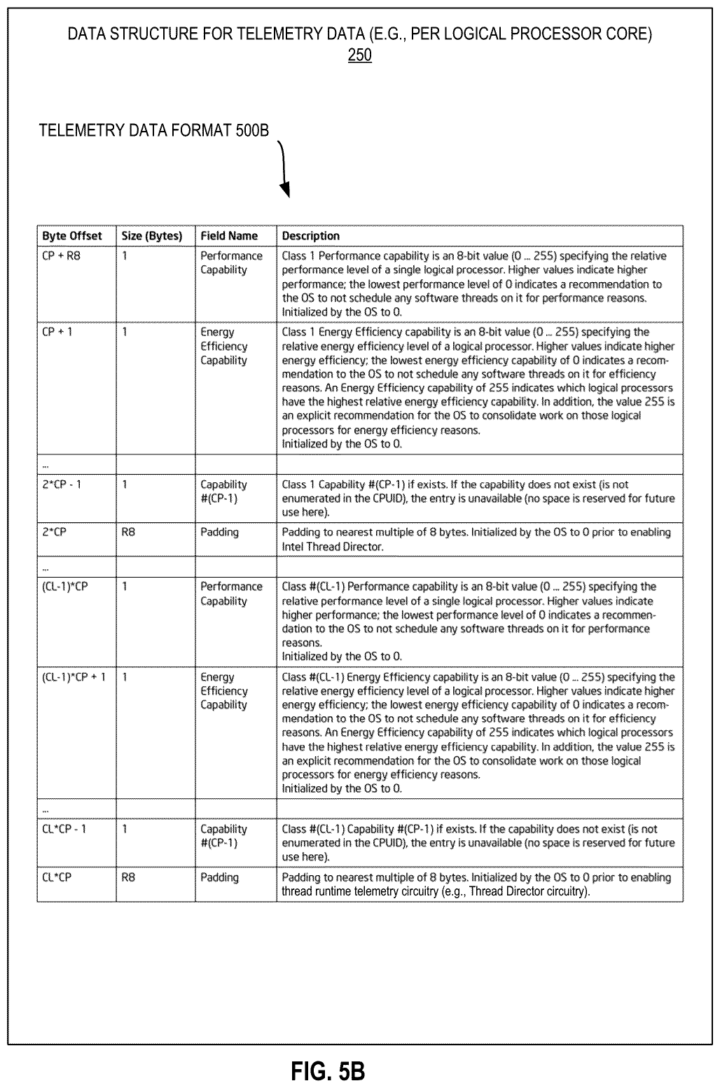

FIG. 6 illustrates a data structure 250 for telemetry data storing an energy efficiency capability value and a performance capability value for each logical processor core of a computer system according to some examples. In certain examples, thread runtime telemetry circuitry 116 (e.g., Thread Director circuitry) is to populate data structure 250 in FIG. 6 during runtime of a processor including logical processor cores to LPn-1 (e.g., this would be LP 0 to 19 for the 20 logical processor core example computer system 100 that includes six SMT physical processor cores of the first type 401 (e.g., 12 logical processor cores) and eight non-SMT physical processor cores of the second type 402. In certain examples, thread runtime telemetry circuitry 116 (e.g., hybrid scaling predictor 240 thereof) is to generate a performance capability (Perf Cap) 242P (e.g., per logical processor core) and/or an energy efficiency capability (EE Cap) 242E (e.g., per logical processor core), and populate data structure 250 in FIG. 6 (e.g., in runtime). In certain examples, this predicted capability is for a current time. In certain examples, the predicted performance capability (Perf Cap) and/or predicted energy efficiency capability (EE Cap) is generated (and populated in data structure 250) for each logical processor core and/or for each class (e.g., class D 600, Class 1 601, Class 2 602, Class 3 603, etc.).

In certain examples, an operating system (e.g., OS scheduler) is to choose between using the predicted performance capability (Perf Cap) and/or predicted energy efficiency capability (EE Cap) to schedule a thread on a particular logical processor (LP) (e.g., LP core), e.g., depending on parameters such as power policy, battery slider, etc.

In certain examples, an Operating System can determine the index for a Logical Processor Entry within the data structure 250 (e.g., Thread Director table) by executing a CPU Identification (CPUID) instruction on that logical processor, e.g., with a corresponding ID value returned to CPUID.06H.0H:EDX[31:16] of that logical processor.

### Checking/Triggering of SMT Core Isolation

Certain examples herein implement the dynamic SMT scheduling disclosed herein, for example, to provide core isolation via forced core parking of logical SMT sibling processors when desired (e.g., when necessary), e.g., while allowing a less restrictive (e.g., “small or idle”) scheduling policy for user-initiated background tasks (e.g., compiler/render, etc.) running on the system to take advantage of SMT physical processor cores (e.g., performance cores (P-cores)) (e.g., big cores). For example, to avoid totally disabling simultaneous multi-threading (SMT) and/or only processing background tasks on less powerful (e.g., non-SMT) physical processor cores (e.g., E-cores) and/or because certain applications spawn threads based on logical core count and not just physical core count (e.g., the OS scheduler does not have the physical core count).

In certain examples, a determination on when to deliver core isolation is dependent on (i) utilization and thread concurrency of foreground tasks (e.g., threads for a foreground application, e.g., application 1 code 168 in FIG. 1) and (ii) overall workload characteristic based on package power and system-wise processor core utilization (e.g., e.g., with an Advanced Configuration and Power Interface (ACPI) standard's “C0” working state utilization percentage being referred to as “C0%”).

FIG. 7 is a flow diagram illustrating operations 700 of a method of performing dynamic simultaneous multi-threading (SMT) scheduling (e.g., including SMT core isolation) according to some examples. Some or all of the operations 700 (or other processes described herein, or variations, and/or combinations thereof) are performed under the control of one or more computer systems configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. One example is, using EPP information, the machine (e.g., processor) can determine which code is high priority/QoS and which one is low priority/QoS, and if those tasks were to be scheduled on an SMT sibling of a same physical core, then provide isolation to higher priority/QoS code.

The operations 700 include, at block 702, determining if an application (e.g., an application that requested the operating system to execute a thread on a processing system) is a foreground application. In certain examples, this determining at block 702 includes checking if the application has a class of service (CLOS) (e.g., stored in a CLOS register of a processor) (e.g., in IA32_PQR_ASSOC MSR (e.g., 0xC8F)) that is below a threshold, for example, where a CLOS value below this threshold (e.g., CLOS=0) means it is a foreground application (e.g., has a high quality of service (high QoS)), e.g., and a CLOS value above this threshold means it is not a foreground application (e.g., it is a background application). In certain examples, this determining at block 702 includes checking if the application has an energy performance preference (EPP) value (e.g., stored in a hardware-controlled performance states (HWP) register (e.g., 0198H)) that is below a threshold, for example, where an EPP value below this threshold means it is a foreground application, e.g., and an EPP value above this threshold means it is not a foreground application (e.g., it is a background application). In certain examples, if the application (e.g., an application that requested the operating system to execute a thread on a processing system) is not a foreground application, the operations 700 cease (e.g., until another application requests the operating system to execute a thread on a processing system) and if it is a foreground (FG) application, the operations 700 proceed to block 704.

The operations 700 further include, at block 704, determining if the foreground application is CPU intensive, e.g., does the foreground application use more than a threshold number of (e.g., a single) logical processor core(s), and if no, proceeding back to block 702, and if yes, proceeding to block 706. In certain examples, this determining at block 704 includes checking if the average CPU utilization for that application (e.g., the application's C0) (e.g., as tracked by performance monitoring circuit 172) is greater than a threshold number of logical processor core(s), e.g., greater than a 100% of a logical processor core.

The operations 700 further include, at block 706, determining if the foreground application is lightly threaded, e.g., is the foreground application to use less than or equal to the number of physical cores that support multi-threading (e.g., SMT P-cores), and if no, proceeding back to block 702, and if yes, proceeding to block 708. In another example, instead of proceeding to block 708, the operations proceed to block 710 for core isolation, e.g., where block 708 is optional or not included. In certain examples, this determining at block 706 includes checking if the concurrency (e.g., number of threads that are to concurrently execute by the application) of the foreground application is less than the SMT core count (e.g., the SMT core count determined from a status register, e.g., MSR 0x35).

The operations 700 further include, at block 708, determining, based on package power and/or CPU utilization (e.g., system-wide C0%), is the system workload sustained, e.g., is there background activity (e.g., background application(s)) that will contend for cores with the foreground application, and if no, proceeding back to block 702, and if yes, proceeding to block 710.

The operations 700 further include, at block 710, applying SMT core isolation.

In certain examples, the SMT core isolation at block 710 includes disabling each SMT physical core's (e.g., of all SMT physical cores of a system) logical cores except for one in each physical core, e.g., the rest of those logical cores of a single physical core being referred to as that one (not-disabled) logical core's “siblings”. Using FIG. 4 as an example, in certain examples this would disable (e.g., not allow the use of) logical core 109_P1B, logical core 109_P2B, through logical core 109_P(X)B.

In certain examples, the SMT core isolation at block 710 includes disabling the sibling logical cores only for those SMT physical core's that are to be used by the foreground application (e.g., not all disabling the sibling logical cores for all the SMT physical cores of a system). Using FIG. 4 as an example, in certain examples the foreground application is to only use logical core 109_P1A of physical core 109_P1, and thus the operations at block 710 would include disabling (e.g., not allow the use of) logical core 109_P1B, but without disabling logical core 109_P2B through logical core 109_P(X)B. Using FIG. 4 as another example, in certain examples the foreground application is to only use logical core 109_P1A of physical core 109_P1 and logical core 109_P2A of physical core 109_P2, and thus the operations at block 710 would include disabling (e.g., not allow the use of) logical core 109_P1B and logical core 109_P2B, but without disabling logical core 109_P(X)B.

In certain examples, SMT core isolation (e.g., at block 710) is trigged for a request (e.g., a request to schedule a thread for an application), by checking:
If X %<foreground application's utilization <Y %
   where X and Y represents foreground utilization thresholds between which SMT sibling logical cores can be parked during sustained workload. In certain examples, if foreground application's usage falls within this range, the foreground application's work does not spill over to SMT sibling logical cores, e.g., such that the SMT siblings may be parked to improve performance. In certain examples, this check also includes checking if “C0” (e.g., where C0 is the active time of that core/CPU) and package power-based system (e.g., SoC) workload detection on the platform is sustained, e.g., indicating sustained background activity that could impact the foreground application's responsiveness.

Referring again to the example of a computer system 100 that includes six SMT physical processor cores of the first type 401 (e.g., 12 logical processor cores) and eight non-SMT physical processor cores of the second type 402, so 14 (6+8) physical processor cores but 20 (12+8) logical processor cores total for such a computer system 100, a trigger for SMT Core Isolation is checking if foreground application utilization (e.g., C0%) is between 100% usage of 1 thread to 100% usage of 14 threads with thread concurrency <14 and sustained background activity, and if that check passed, then take appropriate action to park SMT siblings to improve foreground performance during concurrent workloads.

In certain examples, a trigger for SMT Core Isolation is checking if 100% of 1 thread <Foreground App utilization <100% of (total #of physical cores, e.g., via MSR 0x35), and checking for sustained background activity, and if that check passed, then take appropriate action to park SMT siblings to improve foreground performance during concurrent workloads.

### SMT Core Isolation

In certain examples, upon determining to trigger SMT core isolation, SMT core isolation (e.g., disabling all but one logical core on a set of one or more SMT physical cores) is achieved by configuring platform specific trigger(s) and action(s). In certain examples, upon determining to trigger SMT core isolation, SMT core isolation (e.g., disabling all but one logical core on an SMT physical core) is achieved by updating a run time core parking configuration on the platform (e.g., computer system).

In certain examples, SMT core isolation is achieved by updating run time processor power management configuration settings (e.g., of an OS) to implement SMT core parking. In certain examples, such forced core parking of sibling logical processor cores of SMT physical processor cores is be achieved by limiting a number of logical processors (e.g., CPUs) available for scheduling, for example, by setting a corresponding value into a control value 164 of OS 160 (e.g., “CPMaxCores” value) (e.g., a processor power management (PPM) control value), e.g., a control value which denotes maximum % of unparked processors on the platform. In certain examples, this includes setting the control value 164 (e.g., CPMaxCores)=(#of Physical cores/Total #of Threads)*100.

Referring again to the example of a computer system 100 that includes six SMT physical processor cores of the first type 401 (e.g., 12 logical processor cores) and eight non-SMT physical processor cores of the second type 402, so 14 (6+8) physical processor cores but 20 (12+8) logical processor cores total for such a computer system 100, setting the control value 164 (e.g., CPMaxCores) to 70%=(14/20)*100 will prevent the OS 160 (e.g., OS scheduler 162) from scheduling on the remaining 30% (i.e., 6) SMT siblings.

In certain examples, SMT core isolation (e.g., core parking) is implemented in via hardware, for example, thread runtime telemetry circuitry 116 (e.g., (i) Hardware Guide Scheduler (HGS) (or HGS+) circuitry or (ii) Thread Director circuitry). In certain examples, SMT core isolation (e.g., core parking) is implemented with hardware guided scheduling with a per-logical thread entry. In certain examples, the hardware is used to cause a hint (or other value) to be readable by the OS to avoid (e.g., not use) the SMT sibling cores (e.g., even though they were actually available to perform that work). In certain examples, the processor (e.g., via non-transitory machine-readable medium that stores power management code (e.g., p-code)) is to cause the thread runtime telemetry circuitry 116 (e.g., (i) Hardware Guide Scheduler (HGS) (or HGS+) circuitry or (ii) Thread Director circuitry) to implement SMT core isolation (e.g., core parking), e.g., by modifying values in data structure 250. Referring to FIG. 6, in certain examples if a SMT physical core implements logical processor (LP) (e.g., logical processor core) 0 and logical processor (LP) (e.g., logical processor core) 1, and it is desired to disable logical processor (LP) (e.g., logical processor core) 1 (and not disable LP 0), a corresponding write (e.g., of zero) is performed to the predicted performance capability (Perf Cap) and/or predicted energy efficiency capability (EE Cap) (e.g., in all classes or a subset of applicable classes) for the LP 1 row (the second row in the table in FIG. 6). In certain examples, an indication to use LP 0 may also be written to data structure 250 to fully enable (e.g., encourage) use of LP0, e.g., a corresponding write (e.g., of maximum value, e.g., 255) being performed to the predicted performance capability (Perf Cap) and/or predicted energy efficiency capability (EE Cap) (e.g., in all classes or a subset of applicable classes) for the LP 0 row (the first row in the table in FIG. 6).

The above discusses examples where a data structure 250 is used for telemetry data (e.g., capability values), however it should be understood that the telemetry data (e.g., capability values) may be sourced otherwise (e.g., directly from hybrid scaling predictor 240), e.g. and the telemetry data therefrom may be modified according to this disclosure to implement SMT core isolation (e.g., core parking).

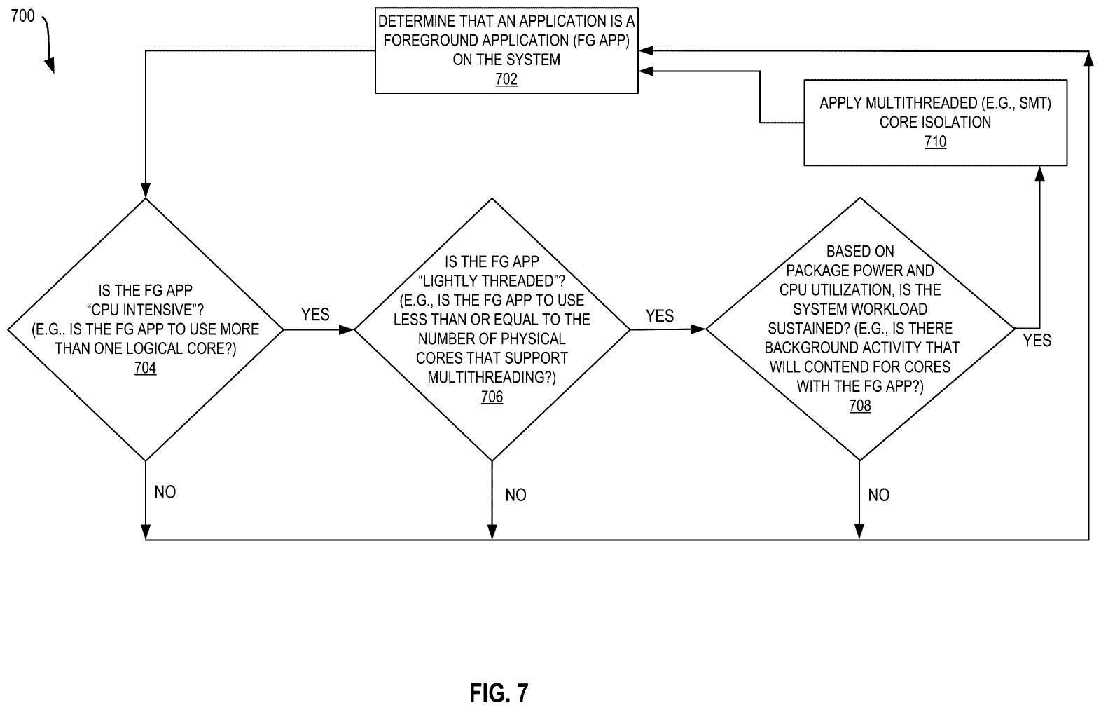

FIG. 8 is a flow diagram illustrating operations 800 of another method of performing dynamic simultaneous multi-threading (SMT) scheduling according to some examples. Some or all of the operations 800 (or other processes described herein, or variations, and/or combinations thereof) are performed under the control of one or more computer systems configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory.

The operations 800 include, at block 802, receiving a request to execute a set of threads of a foreground application on a hardware processor comprising a first plurality of physical processor cores of a first type that implements a plurality of logical processor cores of the first type, and a second plurality of physical processor cores of a second type, wherein each core of the second type implements a plurality of logical processor cores of the second type. The operations 800 further include, at block 804, determining if the set of threads of the foreground application is to use more than a threshold number of logical processor cores and less than or equal to a total number of the first plurality of physical processor cores of the first type and the second plurality of physical processor cores of the second type. The operations 800 further include, at block 806, disabling a second logical core of a physical processor core of the second type, and not disabling a first logical core of the physical processor core of the second type, in response to a determination that the set of threads of the foreground application is to use more than the threshold number of logical processor cores and less than or equal to the total number of the first plurality of physical processor cores of the first type and the second plurality of physical processor cores of the second type.

Exemplary architectures, systems, etc. that the above may be used in are detailed below.

At least some examples of the disclosed technologies can be described in view of the following examples:

Example 1. An apparatus comprising:
a first plurality of physical processor cores of a first type to implement a plurality of logical processor cores of the first type;
a second plurality of physical processor cores of a second type, wherein each core of the second type is to implement a plurality of logical processor cores of the second type; and
circuitry to:
   determine if a set of threads of a foreground application is to use more than a lower threshold (e.g., a threshold number (e.g., one) of logical processor cores) and less than or equal to an upper threshold (e.g., a total number of the first plurality of physical processor cores of the first type and the second plurality of physical processor cores of the second type), and
   disable a second logical core of a physical processor core of the second type, and not disable a first logical core of the physical processor core of the second type, in response to a determination that the set of threads of the foreground application is to use more than the lower threshold number of logical processor cores and less than or equal to the upper threshold (e.g., the total number of the first plurality of physical processor cores of the first type and the second plurality of physical processor cores of the second type).
      Example 2. The apparatus of example 1, wherein the circuitry is further to determine if a set of threads of a background application also to execute on the first plurality of physical processor cores of the first type or the second plurality of physical processor cores of the second type is to contend for any logical core that is to execute the set of threads of the foreground application when the second logical core is disabled, wherein the circuitry is to not disable the second logical core in response to a determination that the set of threads of the background application that is to execute on the first plurality of physical processor cores of the first type or the second plurality of physical processor cores of the second type is to contend for any logical core that is to execute the set of threads of the foreground application when the second logical core is disabled.
      Example 3. The apparatus of any one of examples 1-2, wherein each core of the first type is to implement a single logical processor core of the first type.
      Example 4. The apparatus of example 1, wherein the circuitry is to, in response to the determination that the set of threads of the foreground application is to use more than the threshold number of logical processor cores and less than or equal to the total number of the first plurality of physical processor cores of the first type and the second plurality of physical processor cores of the second type:
disable each second logical core of each physical processor core of the second type that is to execute a thread of the set of threads of the foreground application;
not disable each first logical core of each physical processor core of the second type that is to execute a thread of the set of threads of the foreground application; and
not disable each second logical core of each physical processor core of the second type that is not to execute a thread of the set of threads of the foreground application.
   Example 5. The apparatus of example 1, wherein the circuitry is to, in response to the determination that the set of threads of the foreground application is to use more than the threshold number of logical processor cores and less than or equal to the total number of the first plurality of physical processor cores of the first type and the second plurality of physical processor cores of the second type, disable each second logical core of each physical processor core of the second type.
   Example 6. The apparatus of any one of examples 1-5, wherein the threshold number of logical processor cores is a single logical processor core.
   Example 7. The apparatus of any one of examples 1-6, further comprising a thread runtime telemetry circuit to generate an energy efficiency capability value and/or a performance capability value for each logical processor core of the apparatus, wherein the circuitry is to disable the second logical core of the physical processor core of the second type, and not disable the first logical core of the physical processor core of the second type, by lowering the energy efficiency capability value and/or the performance capability value of the second logical core.
   Example 8. The apparatus of any one of examples 1-7, wherein the circuitry is to disable the second logical core of the physical processor core of the second type, and not disable the first logical core of the physical processor core of the second type, by causing modification of a control value, of an operating system, that sets a maximum percentage of logical processors that are to be in an un-parked state.
   Example 9. A method comprising:
receiving a request to execute a set of threads of a foreground application on a hardware processor comprising a first plurality of physical processor cores of a first type that implements a plurality of logical processor cores of the first type, and a second plurality of physical processor cores of a second type, wherein each core of the second type implements a plurality of logical processor cores of the second type;
determining if the set of threads of the foreground application is to use more than a threshold number of logical processor cores and less than or equal to a total number of the first plurality of physical processor cores of the first type and the second plurality of physical processor cores of the second type; and
disabling a second logical core of a physical processor core of the second type, and not disabling a first logical core of the physical processor core of the second type, in response to a determination that the set of threads of the foreground application is to use more than the threshold number of logical processor cores and less than or equal to the total number of the first plurality of physical processor cores of the first type and the second plurality of physical processor cores of the second type.
   Example 10. The method of example 9, further comprising:
determining if a set of threads of a background application that is to execute on the first plurality of physical processor cores of the first type or the second plurality of physical processor cores of the second type is to contend for any logical core that is to execute the set of threads of the foreground application when the second logical core is disabled; and
not disabling the second logical core in response to a determination that the set of threads of the background application that is to execute on the first plurality of physical processor cores of the first type or the second plurality of physical processor cores of the second type is to contend for any logical core that is to execute the set of threads of the foreground application when the second logical core is disabled.
   Example 11. The method of any one of examples 9-10, wherein each core of the first type is to implement a single logical processor core of the first type.
   Example 12. The method of example 9, further comprising, in response to the determination that the set of threads of the foreground application is to use more than the threshold number of logical processor cores and less than or equal to the total number of the first plurality of physical processor cores of the first type and the second plurality of physical processor cores of the second type:
disabling each second logical core of each physical processor core of the second type that is to execute a thread of the set of threads of the foreground application;
not disabling each first logical core of each physical processor core of the second type that is to execute a thread of the set of threads of the foreground application; and
not disabling each second logical core of each physical processor core of the second type that is not to execute a thread of the set of threads of the foreground application.
   Example 13. The method of example 9, further comprising, in response to the determination that the set of threads of the foreground application is to use more than the threshold number of logical processor cores and less than or equal to the total number of the first plurality of physical processor cores of the first type and the second plurality of physical processor cores of the second type, disabling each second logical core of each physical processor core of the second type.
   Example 14. The method of any one of examples 9-13, wherein the threshold number of logical processor cores is a single logical processor core.
   Example 15. The method of any one of examples 9-14, further comprising generating, by a thread runtime telemetry circuit of the hardware processor, an energy efficiency capability value or a performance capability value for each logical processor core of the hardware processor, wherein the disabling of the second logical core of the physical processor core of the second type, and the not disabling the first logical core of the physical processor core of the second type, comprises lowering the energy efficiency capability value or the performance capability value of the second logical core.
   Example 16. The method of any one of examples 9-15, wherein the disabling of the second logical core of the physical processor core of the second type, and the not disabling the first logical core of the physical processor core of the second type, comprises modifying a control value, of an operating system, that sets a maximum percentage of logical processors that are to be in an un-parked state.
   Example 17. A non-transitory machine-readable medium that stores code (e.g., an O.S.) that when executed by a machine causes the machine to perform a method comprising:
receiving a request to execute a set of threads of a foreground application on a hardware processor comprising a first plurality of physical processor cores of a first type that implements a plurality of logical processor cores of the first type, and a second plurality of physical processor cores of a second type, wherein each core of the second type implements a plurality of logical processor cores of the second type;
determining if the set of threads of the foreground application is to use more than a threshold number of logical processor cores and less than or equal to a total number of the first plurality of physical processor cores of the first type and the second plurality of physical processor cores of the second type; and
disabling a second logical core of a physical processor core of the second type, and not disabling a first logical core of the physical processor core of the second type, in response to a determination that the set of threads of the foreground application is to use more than the threshold number of logical processor cores and less than or equal to the total number of the first plurality of physical processor cores of the first type and the second plurality of physical processor cores of the second type.
   Example 18. The non-transitory machine-readable medium of example 17, wherein the method further comprises:
determining if a set of threads of a background application that is to execute on the first plurality of physical processor cores of the first type or the second plurality of physical processor cores of the second type is to contend for any logical core that is to execute the set of threads of the foreground application when the second logical core is disabled; and
not disabling the second logical core in response to a determination that the set of threads of the background application that is to execute on the first plurality of physical processor cores of the first type or the second plurality of physical processor cores of the second type is to contend for any logical core that is to execute the set of threads of the foreground application when the second logical core is disabled.
   Example 19. The non-transitory machine-readable medium of any one of examples 17-18, wherein each core of the first type is to implement a single logical processor core of the first type.
   Example 20. The non-transitory machine-readable medium of example 17, wherein the method further comprises, in response to the determination that the set of threads of the foreground application is to use more than the threshold number of logical processor cores and less than or equal to the total number of the first plurality of physical processor cores of the first type and the second plurality of physical processor cores of the second type:
disabling each second logical core of each physical processor core of the second type that is to execute a thread of the set of threads of the foreground application;
not disabling each first logical core of each physical processor core of the second type that is to execute a thread of the set of threads of the foreground application; and
not disabling each second logical core of each physical processor core of the second type that is not to execute a thread of the set of threads of the foreground application.
   Example 21. The non-transitory machine-readable medium of example 17, wherein the method further comprises, in response to the determination that the set of threads of the foreground application is to use more than the threshold number of logical processor cores and less than or equal to the total number of the first plurality of physical processor cores of the first type and the second plurality of physical processor cores of the second type, disabling each second logical core of each physical processor core of the second type.
   Example 22. The non-transitory machine-readable medium of any one of examples 17-21, wherein the threshold number of logical processor cores is a single logical processor core.
   Example 23. The non-transitory machine-readable medium of any one of examples 17-22, wherein the method further comprises generating, by a thread runtime telemetry circuit of the hardware processor, an energy efficiency capability value or a performance capability value for each logical processor core of the hardware processor, wherein the disabling of the second logical core of the physical processor core of the second type, and the not disabling the first logical core of the physical processor core of the second type, comprises lowering the energy efficiency capability value or the performance capability value of the second logical core.
   Example 24. The non-transitory machine-readable medium of any one of examples 17-23, wherein the disabling of the second logical core of the physical processor core of the second type, and the not disabling the first logical core of the physical processor core of the second type, comprises modifying a control value, of an operating system, that sets a maximum percentage of logical processors that are to be in an un-parked state.

### Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 9 illustrates an example computing system. Multiprocessor system 900 is an interfaced system and includes a plurality of processors or cores including a first processor 970 and a second processor 980 coupled via an interface 950 such as a point-to-point (P-P) interconnect, a fabric, and/or bus. In some examples, the first processor 970 and the second processor 980 are homogeneous. In some examples, first processor 970 and the second processor 980 are heterogenous. Though the example system 900 is shown to have two processors, the system may have three or more processors, or may be a single processor system. In some examples, the computing system is a system on a chip (SoC).

Processors 970 and 980 are shown including integrated memory controller (IMC) circuitry 972 and 982, respectively. Processor 970 also includes interface circuits 976 and 978; similarly, second processor 980 includes interface circuits 986 and 988. Processors 970, 980 may exchange information via the interface 950 using interface circuits 978, 988. IMCs 972 and 982 couple the processors 970, 980 to respective memories, namely a memory 932 and a memory 934, which may be portions of main memory locally attached to the respective processors.

Processors 970, 980 may each exchange information with a network interface (NW I/F) 990 via individual interfaces 952, 954 using interface circuits 976, 994, 986, 998. The network interface 990 (e.g., one or more of an interconnect, bus, and/or fabric, and in some examples is a chipsct) may optionally exchange information with a coprocessor 938 via an interface circuit 992. In some examples, the coprocessor 938 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared each e (not shown) may be included in either processor 970, 980 or outside of both processors, yet connected with the processors via an interface such as P-P interconnect, such that either or both processors' local each e information may be stored in the shared each e if a processor is placed into a low power mode.

Network interface 990 may be coupled to a first interface 916 via interface circuit 996. In some examples, first interface 916 may be an interface such as a Peripheral Component Interconnect (PCI) interconnect, a PCI Express interconnect or another I/O interconnect. In some examples, first interface 916 is coupled to a power control unit (PCU) 917, which may include circuitry, software, and/or firmware to perform power management operations with regard to the processors 970, 980 and/or co-processor 938. PCU 917 provides control information to a voltage regulator (not shown) to cause the voltage regulator to generate the appropriate regulated voltage. PCU 917 also provides control information to control the operating voltage generated. In various examples, PCU 917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 917 is illustrated as being present as logic separate from the processor 970 and/or processor 980. In other cases, PCU 917 may execute on a given one or more of cores (not shown) of processor 970 or 980. In some cases, PCU 917 may be implemented as a microcontroller (dedicated or general-purpose) or other control logic configured to execute its own dedicated power management code, sometimes referred to as P-code. In yet other examples, power management operations to be performed by PCU 917 may be implemented externally to a processor, such as by way of a separate power management integrated circuit (PMIC) or another component external to the processor. In yet other examples, power management operations to be performed by PCU 917 may be implemented within BIOS or other system software.

Various I/O devices 914 may be coupled to first interface 916, along with a bus bridge 918 which couples first interface 916 to a second interface 920. In some examples, one or more additional processor(s) 915, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 916. In some examples, second interface 920 may be a low pin count (LPC) interface. Various devices may be coupled to second interface 920 including, for example, a keyboard and/or mouse 922, communication devices 927 and storage circuitry 928. Storage circuitry 928 may be one or more non-transitory machine-readable storage media as described below, such as a disk drive or other mass storage device which may include instructions/code and data 930 and may implement the storage 928 in some examples. Further, an audio I/O 924 may be coupled to second interface 920. Note that other architectures than the point-to-point architecture described above are possible. For example, instead of the point-to-point architecture, a system such as multiprocessor system 900 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 10 illustrates a block diagram of an example processor and/or SoC 1000 that may have one or more cores and an integrated memory controller. The solid lined boxes illustrate a processor 1000 with a single core 1002(A), system agent unit circuitry 1010, and a set of one or more interface controller unit(s) circuitry 1016, while the optional addition of the dashed lined boxes illustrates an alternative processor 1000 with multiple cores 1002(A)-(N), a set of one or more integrated memory controller unit(s) circuitry 1014 in the system agent unit circuitry 1010. and special purpose logic 1008, as well as a set of one or more interface controller units circuitry 1016. Note that the processor 1000 may be one of the processors 970 or 980, or co-processor 938 or 915 of FIG. 9.

Thus, different implementations of the processor 1000 may include: 1) a CPU with the special purpose logic 1008 being integrated graphics and/or scientific (throughput) logic (which may include one or more cores, not shown), and the cores 1002(A)-(N) being one or more general purpose cores (e.g., general purpose in-order cores, general purpose out-of-order cores, or a combination of the two); 2) a coprocessor with the cores 1002(A)-(N) being a large number of special purpose cores intended primarily for graphics and/or scientific (throughput); and 3) a coprocessor with the cores 1002(A)-(N) being a large number of general purpose in-order cores. Thus, the processor 1000 may be a general-purpose processor, coprocessor, or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of each e unit(s) circuitry 1004(A)-(N) within the cores 1002(A)-(N), a set of one or more shared each e unit(s) circuitry 1006, and external memory (not shown) coupled to the set of integrated memory controller unit(s) circuitry 1014. The set of one or more shared each e unit(s) circuitry 1006 may include one or more mid-level each es, such as level 2 (L2), level 3 (L3), level 4 (L4), or other levels of each e, such as a last level each e (LLC), and/or combinations thereof. While in some examples interface network circuitry 1012 (e.g., a ring interconnect) interfaces the special purpose logic 1008 (e.g., integrated graphics logic), the set of shared each e unit(s) circuitry 1006, and the system agent unit circuitry 1010, alternative examples use any number of well-known techniques for interfacing such units. In some examples, coherency is maintained between one or more of the shared each e unit(s) circuitry 1006 and cores 1002(A)-(N). In some examples, interface controller units circuitry 1016 couple the cores 1002 to one or more other devices 1018 such as one or more I/O devices, storage, one or more communication devices (e.g., wireless networking, wired networking, etc.), etc.

In some examples, one or more of the cores 1002(A)-(N) are capable of multi-threading. The system agent unit circuitry 1010 includes those components coordinating and operating cores 1002(A)-(N). The system agent unit circuitry 1010 may include, for example, power control unit (PCU) circuitry and/or display unit circuitry (not shown). The PCU may be or may include logic and components needed for regulating the power state of the cores 1002(A)-(N) and/or the special purpose logic 1008 (e.g., integrated graphics logic). The display unit circuitry is for driving one or more externally connected displays.

The cores 1002(A)-(N) may be homogenous in terms of instruction set architecture (ISA). Alternatively, the cores 1002(A)-(N) may be heterogeneous in terms of ISA; that is, a subset of the cores 1002(A)-(N) may be capable of executing an ISA, while other cores may be capable of executing only a subset of that ISA or another ISA.

### Example Core Architectures—In-Order and Out-of-Order Core Block Diagram

FIG. 11A is a block diagram illustrating both an example in-order pipeline and an example register renaming, out-of-order issue/execution pipeline according to examples. FIG. 11B is a block diagram illustrating both an example in-order architecture core and an example register renaming, out-of-order issue/execution architecture core to be included in a processor according to examples. The solid lined boxes in FIGS. 11A-11B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11A, a processor pipeline 1100 includes a fetch stage 1102, an optional length decoding stage 1104, a decode stage 1106, an optional allocation (Alloc) stage 1108, an optional renaming stage 1110, a schedule (also known as a dispatch or issue) stage 1112, an optional register read/memory read stage 1114, an execute stage 1116, a write back/memory write stage 1118, an optional exception handling stage 1122, and an optional commit stage 1124. One or more operations can be performed in each of these processor pipeline stages. For example, during the fetch stage 1102, one or more instructions are fetched from instruction memory, and during the decode stage 1106, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1106 and the register read/memory read stage 1114 may be combined into one pipeline stage. In one example, during the execute stage 1116, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 11B may implement the pipeline 1100 as follows: 1) the instruction fetch circuitry 1138 performs the fetch and length decoding stages 1102 and 1104; 2) the decode circuitry 1140 performs the decode stage 1106; 3) the rename/allocator unit circuitry 1152 performs the allocation stage 1108 and renaming stage 1110; 4) the scheduler(s) circuitry 1156 performs the schedule stage 1112; 5) the physical register file(s) circuitry 1158 and the memory unit circuitry 1170 perform the register read/memory read stage 1114; the execution cluster(s) 1160 perform the execute stage 1116; 6) the memory unit circuitry 1170 and the physical register file(s) circuitry 1158 perform the write back/memory write stage 1118; 7) various circuitry may be involved in the exception handling stage 1122; and 8) the retirement unit circuitry 1154 and the physical register file(s) circuitry 1158 perform the commit stage 1124.

FIG. 11B shows a processor core 1190 including front-end unit circuitry 1130 coupled to execution engine unit circuitry 1150, and both are coupled to memory unit circuitry 1170. The core 1190 may be a reduced instruction set architecture computing (RISC) core, a complex instruction set architecture computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front-end unit circuitry 1130 may include branch prediction circuitry 1132 coupled to instruction each e circuitry 1134, which is coupled to an instruction translation lookaside buffer (TLB) 1136, which is coupled to instruction fetch circuitry 1138, which is coupled to decode circuitry 1140. In one example, the instruction each e circuitry 1134 is included in the memory unit circuitry 1170 rather than the front-end circuitry 1130. The decode circuitry 1140 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1140 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1140 may be implemented using various different mechanisms. Examples of suitable mechanisms include, but are not limited to, look-up tables, hardware implementations, programmable logic arrays (PLAs), microcode read only memories (ROMs), etc. In one example, the core 1190 includes a microcode ROM (not shown) or other medium that stores microcode for certain macroinstructions (e.g., in decode circuitry 1140 or otherwise within the front-end circuitry 1130). In one example, the decode circuitry 1140 includes a micro-operation (micro-op) or operation each e (not shown) to hold/each e decoded operations, micro-tags, or micro-operations generated during the decode or other stages of the processor pipeline 1100. The decode circuitry 1140 may be coupled to rename/allocator unit circuitry 1152 in the execution engine circuitry 1150.

The execution engine circuitry 1150 includes the rename/allocator unit circuitry 1152 coupled to retirement unit circuitry 1154 and a set of one or more scheduler(s) circuitry 1156. The scheduler(s) circuitry 1156 represents any number of different schedulers, including reservations stations, central instruction window, etc. In some examples, the scheduler(s) circuitry 1156 can include arithmetic logic unit (ALU) scheduler/scheduling circuitry, ALU queues, address generation unit (AGU) scheduler/scheduling circuitry, AGU queues, etc. The scheduler(s) circuitry 1156 is coupled to the physical register file(s) circuitry 1158. Each of the physical register file(s) circuitry 1158 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1158 includes vector registers unit circuitry, writemask registers unit circuitry, and scalar register unit circuitry. These register units may provide architectural vector registers, vector mask registers, general-purpose registers, etc. The physical register file(s) circuitry 1158 is coupled to the retirement unit circuitry 1154 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1154 and the physical register file(s) circuitry 1158 are coupled to the execution cluster(s) 1160. The execution cluster(s) 1160 includes a set of one or more execution unit(s) circuitry 1162 and a set of one or more memory access circuitry 1164. The execution unit(s) circuitry 1162 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1156, physical register file(s) circuitry 1158, and execution cluster(s) 1160 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1164). It should also be understood that where separate pipelines are used, one or more of these pipelines may be out-of-order issue/execution and the rest in-order.

In some examples, the execution engine unit circuitry 1150 may perform load store unit (LSU) address/data pipelining to an Advanced Microcontroller Bus (AMB) interface (not shown), and address phase and writeback, data phase load, store, and branches.

The set of memory access circuitry 1164 is coupled to the memory unit circuitry 1170, which includes data TLB circuitry 1172 coupled to data each e circuitry 1174 coupled to level 2 (L2) each e circuitry 1176. In one example, the memory access circuitry 1164 may include load unit circuitry, store address unit circuitry, and store data unit circuitry, each of which is coupled to the data TLB circuitry 1172 in the memory unit circuitry 1170. The instruction each e circuitry 1134 is further coupled to the level 2 (L2) each e circuitry 1176 in the memory unit circuitry 1170. In one example, the instruction each e 1134 and the data each e 1174 are combined into a single instruction and data each e (not shown) in L2 each e circuitry 1176, level 3 (L3) each e circuitry (not shown), and/or main memory. The L2 each e circuitry 1176 is coupled to one or more other levels of each e and eventually to a main memory.

The core 1190 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1190 includes logic to support a packed data instruction set architecture extension (e.g., AVX1, AVX2), thereby allowing the operations used by many multimedia applications to be performed using packed data.

### Example Execution Unit(s) Circuitry.

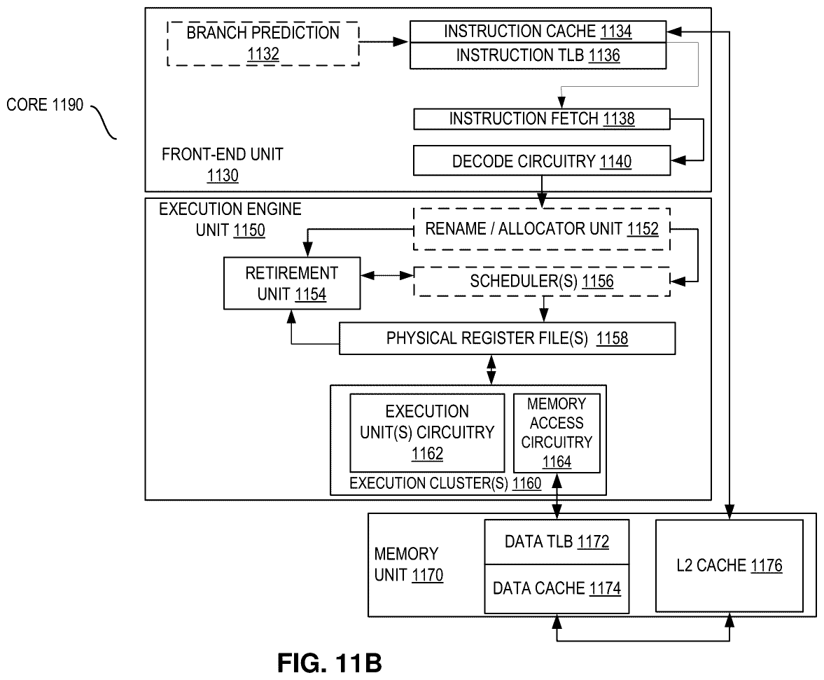

FIG. 12 illustrates examples of execution unit(s) circuitry, such as execution unit(s) circuitry 1162 of FIG. 11B. As illustrated, execution unit(s) circuitry 1162 may include one or more ALU circuits 1201, optional vector/single instruction multiple data (SIMD) circuits 1203, load/store circuits 1205, branch/jump circuits 1207, and/or Floating-point unit (FPU) circuits 1209. ALU circuits 1201 perform integer arithmetic and/or Boolean operations. Vector/SIMD circuits 1203 perform vector/SIMD operations on packed data (such as SIMD/vector registers). Load/store circuits 1205 execute load and store instructions to load data from memory into registers or store from registers to memory. Load/store circuits 1205 may also generate addresses. Branch/jump circuits 1207 cause a branch or jump to a memory address depending on the instruction. FPU circuits 1209 perform floating-point arithmetic. The width of the execution unit(s) circuitry 1162 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

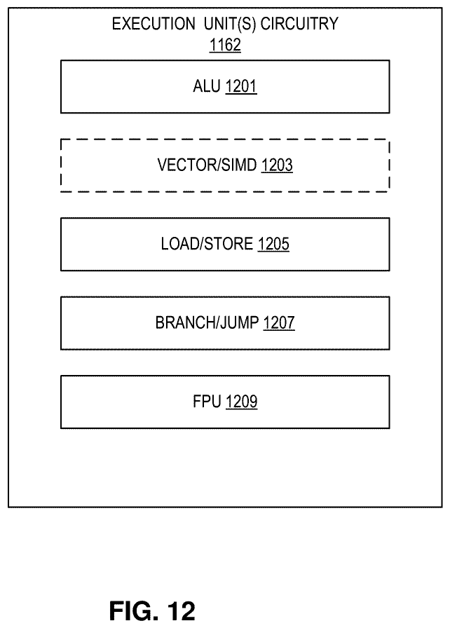

FIG. 13 is a block diagram of a register architecture 1300 according to some examples. As illustrated, the register architecture 1300 includes vector/SIMD registers 1310 that vary from 128-bit to 1,024 bits width. In some examples, the vector/SIMD registers 1310 are physically 512-bits and, depending upon the mapping, only some of the lower bits are used. For example, in some examples, the vector/SIMD registers 1310 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1300 includes writemask/predicate registers 1315. For example, in some examples, there are 8 writemask/predicate registers (sometimes called k0 through k7) that are each 16-bit, 32-bit, 64-bit, or 128-bit in size. Writemask/predicate registers 1315 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1315 corresponds to a data element position of the destination. In other examples, the writemask/predicate registers 1315 are scalable and consists of a set number of enable bits for a given vector element (e.g., 8 enable bits per 64-bit vector element).

The register architecture 1300 includes a plurality of general-purpose registers 1325. These registers may be 16-bit, 32-bit, 64-bit, etc. and can be used for scalar operations. In some examples, these registers are referenced by the names RAX, RBX, RCX, RDX, RBP, RSI, RDI, RSP. and R8 through R15.

In some examples, the register architecture 1300 includes scalar floating-point (FP) register file 1345 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1340 (e.g., EFLAGS, RFLAGS, etc.) store status and control information for arithmetic, compare, and system operations. For example, the one or more flag registers 1340 may store condition code information such as carry, parity, auxiliary carry, zero, sign, and overflow. In some examples, the one or more flag registers 1340 are called program status and control registers.

Segment registers 1320 contain segment points for use in accessing memory. In some examples, these registers are referenced by the names CS, DS, SS, ES, FS, and GS.

Machine specific registers (MSRs) 1335 control and report on processor performance. Most MSRs 1335 handle system-related functions and are not accessible to an application program. Machine check registers 1360 consist of control, status, and error reporting MSRs that are used to detect and report on hardware errors.

One or more instruction pointer register(s) 1330 store an instruction pointer value. Control register(s) 1355 (e.g., CR0-CR4) determine the operating mode of a processor (e.g., processor 970, 980, 938, 915, and/or 1000) and the characteristics of a currently executing task. Debug registers 1350 control and allow for the monitoring of a processor or core's debugging operations.

Memory (mem) management registers 1365 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1300 may, for example, be used in register file 108, or physical register file(s) circuitry 1158.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

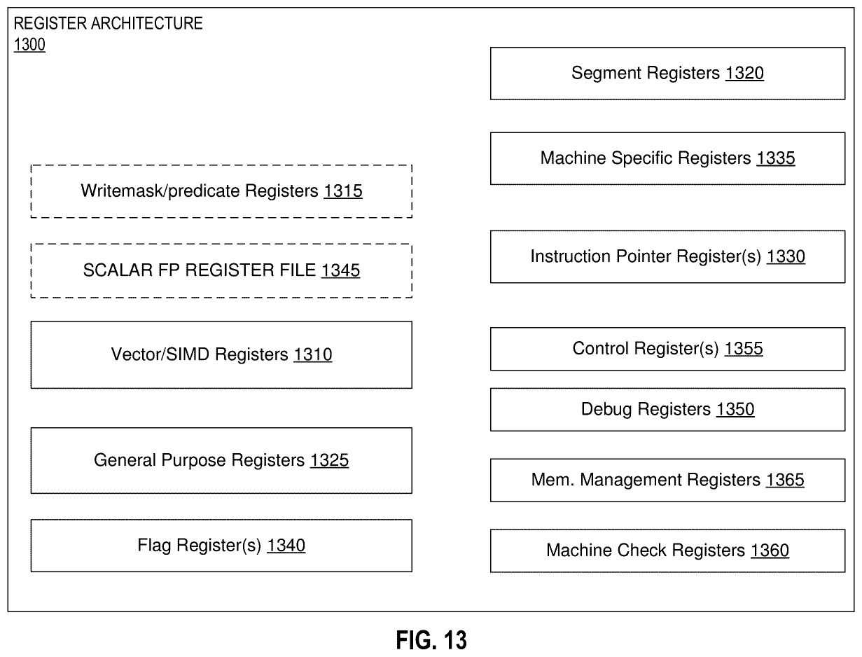

FIG. 14 illustrates examples of an instruction format. As illustrated, an instruction may include multiple components including, but not limited to, one or more fields for: one or more prefixes 1401, an opcode 1403, addressing information 1405 (e.g., register identifiers, memory addressing information, etc.), a displacement value 1407, and/or an immediate value 1409. Note that some instructions utilize some or all the fields of the format whereas others may only use the field for the opcode 1403. In some examples, the order illustrated is the order in which these fields are to be encoded, however, it should be appreciated that in other examples these fields may be encoded in a different order, combined, etc.

The prefix(es) field(s) 1401, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1403 is used to at least partially define the operation to be performed upon a decoding of the instruction. In some examples, a primary opcode encoded in the opcode field 1403 is one, two, or three bytes in length. In other examples, a primary opcode can be a different length. An additional 3-bit opcode field is sometimes encoded in another field.

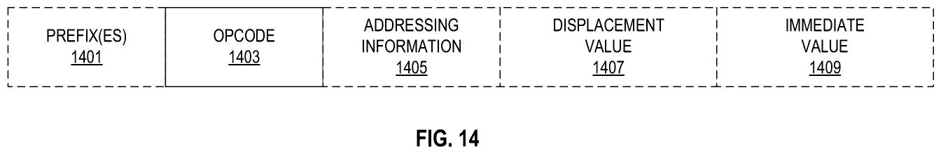

The addressing information field 1405 is used to address one or more operands of the instruction, such as a location in memory or one or more registers. FIG. 15 illustrates examples of the addressing information field 1405. In this illustration, an optional MOD R/M byte 1502 and an optional Scale, Index, Base (SIB) byte 1504 are shown. The MOD R/M byte 1502 and the SIB byte 1504 are used to encode up to two operands of an instruction, each of which is a direct register or effective memory address. Note that both of these fields are optional in that not all instructions include one or more of these fields. The MOD R/M byte 1502 includes a MOD field 1542, a register (reg) field 1544, and R/M field 1546.

The content of the MOD field 1542 distinguishes between memory access and non-memory access modes. In some examples, when the MOD field 1542 has a binary value of 11 (11b), a register-direct addressing mode is utilized, and otherwise a register-indirect addressing mode is used.

The register field 1544 may encode either the destination register operand or a source register operand or may encode an opcode extension and not be used to encode any instruction operand. The content of register field 1544, directly or through address generation, specifies the locations of a source or destination operand (either in a register or in memory). In some examples, the register field 1544 is supplemented with an additional bit from a prefix (e.g., prefix 1401) to allow for greater addressing.

The R/M field 1546 may be used to encode an instruction operand that references a memory address or may be used to encode either the destination register operand or a source register operand. Note the R/M field 1546 may be combined with the MOD field 1542 to dictate an addressing mode in some examples.

The SIB byte 1504 includes a scale field 1552, an index field 1554, and a base field 1556 to be used in the generation of an address. The scale field 1552 indicates a scaling factor. The index field 1554 specifies an index register to use. In some examples, the index field 1554 is supplemented with an additional bit from a prefix (e.g., prefix 1401) to allow for greater addressing. The base field 1556 specifies a base register to use. In some examples, the base field 1556 is supplemented with an additional bit from a prefix (e.g., prefix 1401) to allow for greater addressing. In practice, the content of the scale field 1552 allows for the scaling of the content of the index field 1554 for memory address generation (e.g., for address generation that uses 2scale*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1407 provides this value. Additionally, in some examples, a displacement factor usage is encoded in the MOD field of the addressing information field 1405 that indicates a compressed displacement scheme for which a displacement value is calculated and stored in the displacement field 1407.

In some examples, the immediate value field 1409 specifies an immediate value for the instruction. An immediate value may be encoded as a 1-byte value, a 2-byte value, a 4-byte value, etc.

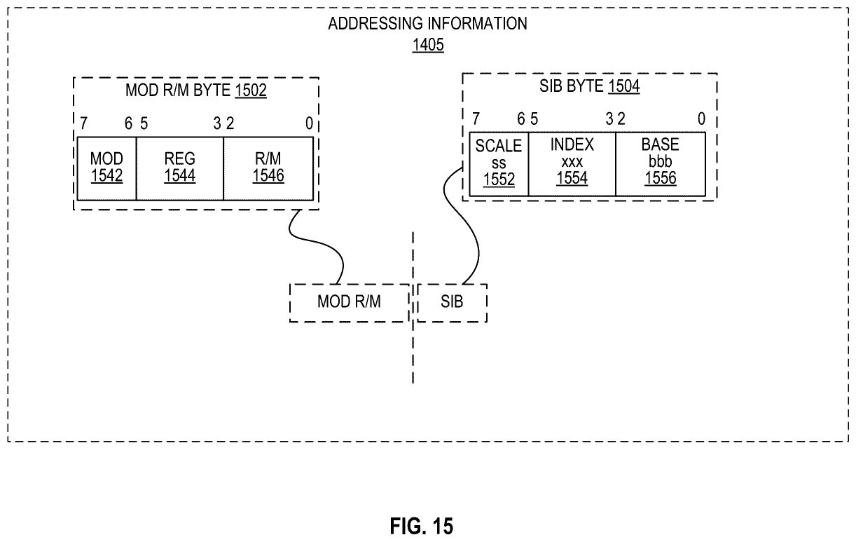

FIG. 16 illustrates examples of a first prefix 1401(A). In some examples, the first prefix 1401(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1401(A) may specify up to three registers using 3-bit fields depending on the format: 1) using the reg field 1544 and the R/M field 1546 of the MOD R/M byte 1502; 2) using the MOD R/M byte 1502 with the SIB byte 1504 including using the reg field 1544 and the base field 1556 and index field 1554; or 3) using the register field of an opcode.

In the first prefix 1401(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 1544 and MOD R/M R/M field 1546 alone can each only address 8 registers.

In the first prefix 1401(A), bit position 2 (R) may be an extension of the MOD R/M reg field 1544 and may be used to modify the MOD R/M reg field 1544 when that field encodes a general-purpose register, a 64-bit packed data register (e.g., an SSE register), or a control or debug register. R is ignored when MOD R/M byte 1502 specifies other registers or defines an extended opcode.

Bit position 1 (X) may modify the SIB byte index field 1554.

Bit position 0 (B) may modify the base in the MOD R/M R/M field 1546 or the SIB byte base field 1556; or it may modify the opcode register field used for accessing general purpose registers (e.g., general purpose registers 1325).

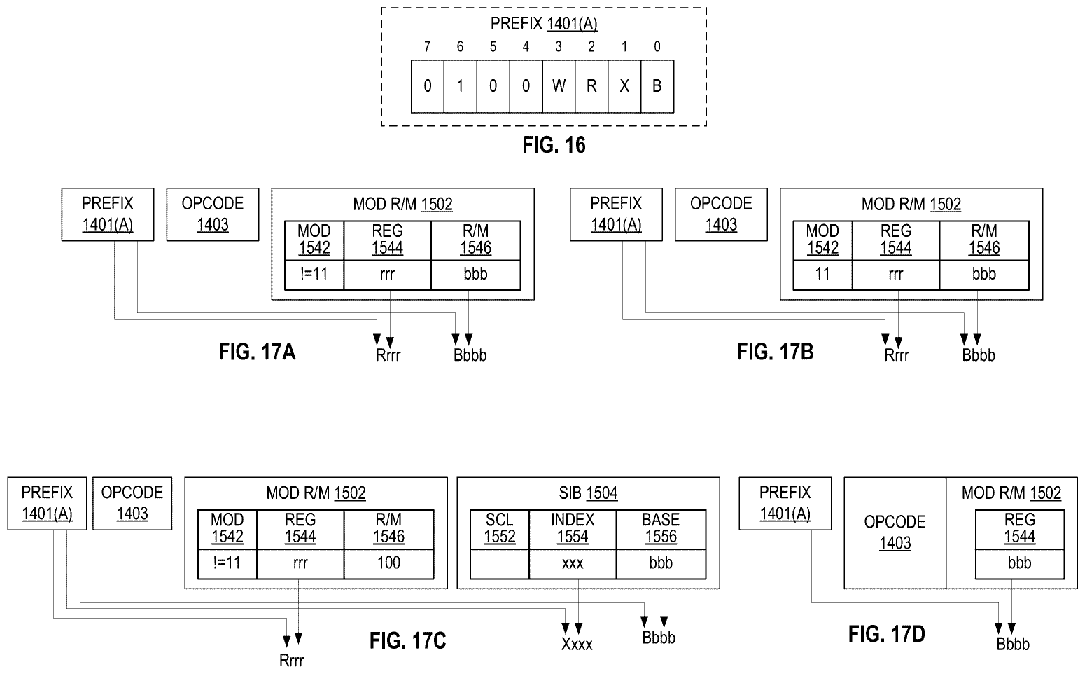

FIGS. 17A-17D illustrate examples of how the R, X, and B fields of the first prefix 1401(A) are used. FIG. 17A illustrates R and B from the first prefix 1401(A) being used to extend the reg field 1544 and R/M field 1546 of the MOD R/M byte 1502 when the SIB byte 15 04 is not used for memory addressing. FIG. 17B illustrates R and B from the first prefix 1401(A) being used to extend the reg field 1544 and R/M field 1546 of the MOD R/M byte 1502 when the SIB byte 15 04 is not used (register-register addressing). FIG. 17C illustrates R, X, and B from the first prefix 1401(A) being used to extend the reg field 1544 of the MOD R/M byte 1502 and the index field 1554 and base field 1556 when the SIB byte 15 04 being used for memory addressing. FIG. 17D illustrates B from the first prefix 1401(A) being used to extend the reg field 1544 of the MOD R/M byte 1502 when a register is encoded in the opcode 1403.

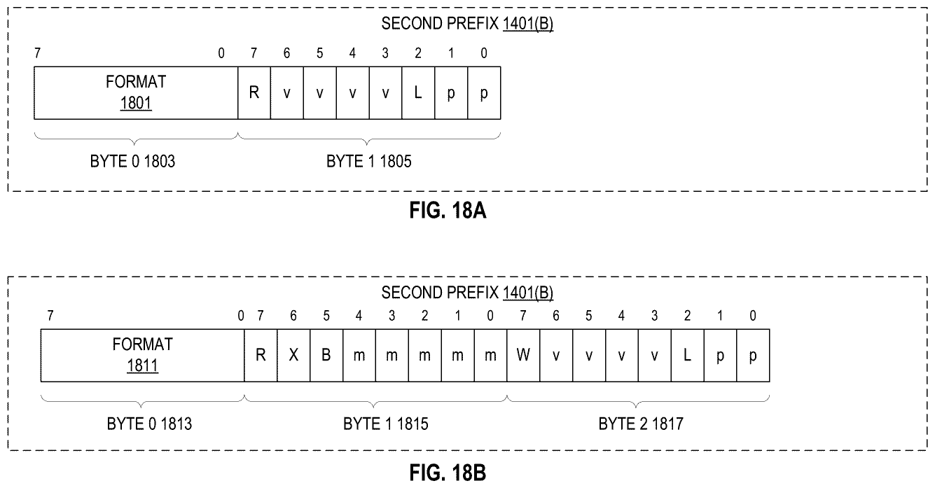

FIGS. 18A-18B illustrate examples of a second prefix 1401(B). In some examples, the second prefix 1401(B) is an example of a VEX prefix. The second prefix 1401(B) encoding allows instructions to have more than two operands, and allows SIMD vector registers (e.g., vector/SIMD registers 1310) to be longer than 64-bits (e.g., 128-bit and 256-bit). The use of the second prefix 1401(B) provides for three-operand (or more) syntax. For example, previous two-operand instructions performed operations such as A=A+B, which overwrites a source operand. The use of the second prefix 1401(B) enables operands to perform nondestructive operations such as A=B+C.

In some examples, the second prefix 1401(B) comes in two forms—a two-byte form and a three-byte form. The two-byte second prefix 1401(B) is used mainly for 128-bit, scalar, and some 256-bit instructions; while the three-byte second prefix 1401(B) provides a compact replacement of the first prefix 1401(A) and 3-byte opcode instructions.

FIG. 18A illustrates examples of a two-byte form of the second prefix 1401(B). In one example, a format field 1801 (byte 0 1803) contains the value C5H. In one example, byte 1 1805 includes an “R” value in bit[7]. This value is the complement of the “R” value of the first prefix 1401(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1546 to encode the instruction operand that references a memory address or encode either the destination register operand or a source register operand.

Instructions that use this prefix may use the MOD R/M reg field 1544 to encode either the destination register operand or a source register operand, or to be treated as an opcode extension and not used to encode any instruction operand.

For instruction syntax that support four operands, vvvv, the MOD R/M R/M field 1546 and the MOD R/M reg field 1544 encode three of the four operands. Bits[7:4] of the immediate value field 1409 are then used to encode the third source register operand.

FIG. 18B illustrates examples of a three-byte form of the second prefix 1401(B). In one example, a format field 1811 (byte 0 1813) contains the value C4H. Byte 1 1815 includes in bits[7:5] “R,” “X,” and “B” which are the complements of the same values of the first prefix 1401(A). Bits[4:0] of byte 1 1815 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 1817 is used similar to W of the first prefix 1401(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1546 to encode the instruction operand that references a memory address or encode either the destination register operand or a source register operand.

Instructions that use this prefix may use the MOD R/M reg field 1544 to encode either the destination register operand or a source register operand, or to be treated as an opcode extension and not used to encode any instruction operand.

For instruction syntax that support four operands, vvvv, the MOD R/M R/M field 1546, and the MOD R/M reg field 1544 encode three of the four operands. Bits[7:4] of the immediate value field 1409 are then used to encode the third source register operand.

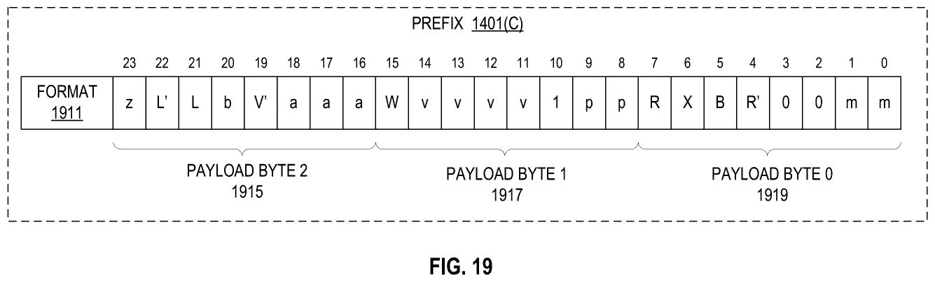

FIG. 19 illustrates examples of a third prefix 1401(C). In some examples, the third prefix 1401(C) is an example of an EVEX prefix. The third prefix 1401(C) is a four-byte prefix.

The third prefix 1401(C) can encode 32 vector registers (e.g., 128-bit, 256-bit, and 512-bit registers) in 64-bit mode. In some examples, instructions that utilize a writemask/opmask (sec discussion of registers in a previous FIG, such as FIG. 13) or predication utilize this prefix. Opmask register allow for conditional processing or selection control. Opmask instructions, whose source/destination operands are opmask registers and treat the content of an opmask register as a single value, are encoded using the second prefix 1401(B).

The third prefix 1401(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1401(C) is a format field 1911 that has a value, in one example, of 62H. Subsequent bytes are referred to as payload bytes 1915-1919 and collectively form a 24-bit value of P[23:0] providing specific capability in the form of one or more fields (detailed herein).

In some examples, P[1:0] of payload byte 1919 are identical to the low two mm bits. P[3:2] are reserved in some examples. Bit P[4] (R′) allows access to the high 16 vector register sct when combined with P[7] and the MOD R/M reg field 1544. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1544 and MOD R/M R/M field 1546. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1401(A) and second prefix 1411(B) and may serve as an opcode extension bit or operand size promotion.

P[18:16] specify the index of a register in the opmask (writemask) registers (e.g., writemask/predicate registers 1315). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1401(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

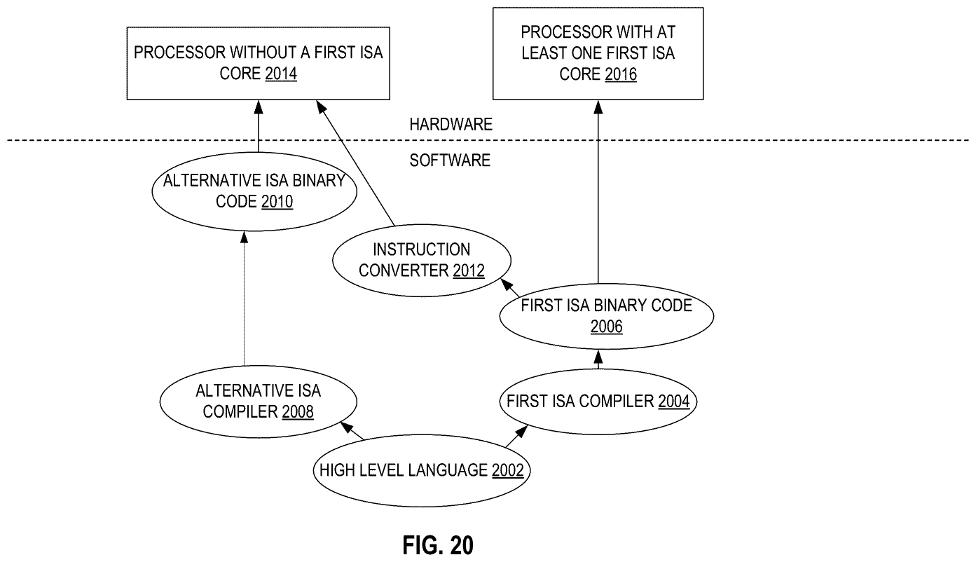

FIG. 20 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 20 shows a program in a high-level language 2002 may be compiled using a first ISA compiler 2004 to generate first ISA binary code 2006 that may be natively executed by a processor with at least one first ISA core 2016. The processor with at least one first ISA core 2016 represents any processor that can perform substantially the same functions as an Intel® processor with at least one first ISA core by compatibly executing or otherwise processing (1) a substantial portion of the first ISA or (2) object code versions of applications or other software targeted to run on an Intel® processor with at least one first ISA core, in order to achieve substantially the same result as a processor with at least one first ISA core. The first ISA compiler 2004 represents a compiler that is operable to generate first ISA binary code 2006 (e.g., object code) that can, with or without additional linkage processing, be executed on the processor with at least one first ISA core 2016. Similarly, FIG. 20 shows the program in the high-level language 2002 may be compiled using an alternative ISA compiler 2008 to generate alternative ISA binary code 2010 that may be natively executed by a processor without a first ISA core 2014. The instruction converter 2012 is used to convert the first ISA binary code 2006 into code that may be natively executed by the processor without a first ISA core 2014. This converted code is not necessarily to be the same as the alternative ISA binary code 2010; however, the converted code will accomplish the general operation and be made up of instructions from the alternative ISA. Thus, the instruction converter 2012 represents software, firmware, hardware, or a combination thereof that, through emulation, simulation, or any other process, allows a processor or other electronic device that does not have a first ISA processor or core to execute the first ISA binary code 2006.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (e.g., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a first plurality of physical processor cores of a first type to implement a plurality of logical processor cores of the first type;
a second plurality of physical processor cores of a second type, wherein each core of the second type is to implement a plurality of logical processor cores of the second type; and
circuitry to:
determine if a set of threads of a foreground application is to use more than a threshold number of logical processor cores and less than or equal to a total number of the first plurality of physical processor cores of the first type and the second plurality of physical processor cores of the second type, and
disable a second logical core of a physical processor core of the second type, and not disable a first logical core of the physical processor core of the second type, in response to a determination that the set of threads of the foreground application is to use more than the threshold number of logical processor cores and less than or equal to the total number of the first plurality of physical processor cores of the first type and the second plurality of physical processor cores of the second type.

2. The apparatus of claim 1, wherein the circuitry is further to determine if a set of threads of a background application also to execute on the first plurality of physical processor cores of the first type or the second plurality of physical processor cores of the second type is to contend for any logical core that is to execute the set of threads of the foreground application when the second logical core is disabled, wherein the circuitry is to not disable the second logical core in response to a determination that the set of threads of the background application that is to execute on the first plurality of physical processor cores of the first type or the second plurality of physical processor cores of the second type is to contend for any logical core that is to execute the set of threads of the foreground application when the second logical core is disabled.

3. The apparatus of claim 1, wherein each core of the first type is to implement a single logical processor core of the first type.

4. The apparatus of claim 1, wherein the circuitry is to, in response to the determination that the set of threads of the foreground application is to use more than the threshold number of logical processor cores and less than or equal to the total number of the first plurality of physical processor cores of the first type and the second plurality of physical processor cores of the second type:
disable each second logical core of each physical processor core of the second type that is to execute a thread of the set of threads of the foreground application;
not disable each first logical core of each physical processor core of the second type that is to execute a thread of the set of threads of the foreground application; and
not disable each second logical core of each physical processor core of the second type that is not to execute a thread of the set of threads of the foreground application.

5. The apparatus of claim 1, wherein the circuitry is to, in response to the determination that the set of threads of the foreground application is to use more than the threshold number of logical processor cores and less than or equal to the total number of the first plurality of physical processor cores of the first type and the second plurality of physical processor cores of the second type, disable each second logical core of each physical processor core of the second type.

6. The apparatus of claim 1, wherein the threshold number of logical processor cores is a single logical processor core.

7. The apparatus of claim 1, further comprising a thread runtime telemetry circuit to generate an energy efficiency capability value or a performance capability value for each logical processor core of the apparatus, wherein the circuitry is to disable the second logical core of the physical processor core of the second type, and not disable the first logical core of the physical processor core of the second type, by lowering the energy efficiency capability value or the performance capability value of the second logical core.

8. The apparatus of claim 1, wherein the circuitry is to disable the second logical core of the physical processor core of the second type, and not disable the first logical core of the physical processor core of the second type, by causing modification of a control value, of an operating system, that sets a maximum percentage of logical processors that are to be in an un-parked state.

9. A method comprising:
receiving a request to execute a set of threads of a foreground application on a hardware processor comprising a first plurality of physical processor cores of a first type that implements a plurality of logical processor cores of the first type, and a second plurality of physical processor cores of a second type, wherein each core of the second type implements a plurality of logical processor cores of the second type;
determining if the set of threads of the foreground application is to use more than a threshold number of logical processor cores and less than or equal to a total number of the first plurality of physical processor cores of the first type and the second plurality of physical processor cores of the second type; and
disabling a second logical core of a physical processor core of the second type, and not disabling a first logical core of the physical processor core of the second type, in response to a determination that the set of threads of the foreground application is to use more than the threshold number of logical processor cores and less than or equal to the total number of the first plurality of physical processor cores of the first type and the second plurality of physical processor cores of the second type.

10. The method of claim 9, further comprising:
determining if a set of threads of a background application that is to execute on the first plurality of physical processor cores of the first type or the second plurality of physical processor cores of the second type is to contend for any logical core that is to execute the set of threads of the foreground application when the second logical core is disabled; and
not disabling the second logical core in response to a determination that the set of threads of the background application that is to execute on the first plurality of physical processor cores of the first type or the second plurality of physical processor cores of the second type is to contend for any logical core that is to execute the set of threads of the foreground application when the second logical core is disabled.

11. The method of claim 9, wherein each core of the first type is to implement a single logical processor core of the first type.

12. The method of claim 9, further comprising, in response to the determination that the set of threads of the foreground application is to use more than the threshold number of logical processor cores and less than or equal to the total number of the first plurality of physical processor cores of the first type and the second plurality of physical processor cores of the second type:
disabling each second logical core of each physical processor core of the second type that is to execute a thread of the set of threads of the foreground application;
not disabling each first logical core of each physical processor core of the second type that is to execute a thread of the set of threads of the foreground application; and
not disabling each second logical core of each physical processor core of the second type that is not to execute a thread of the set of threads of the foreground application.

13. The method of claim 9, further comprising, in response to the determination that the set of threads of the foreground application is to use more than the threshold number of logical processor cores and less than or equal to the total number of the first plurality of physical processor cores of the first type and the second plurality of physical processor cores of the second type, disabling each second logical core of each physical processor core of the second type.

14. The method of claim 9, wherein the threshold number of logical processor cores is a single logical processor core.

15. The method of claim 9, further comprising generating, by a thread runtime telemetry circuit of the hardware processor, an energy efficiency capability value or a performance capability value for each logical processor core of the hardware processor, wherein the disabling of the second logical core of the physical processor core of the second type, and the not disabling the first logical core of the physical processor core of the second type, comprises lowering the energy efficiency capability value or the performance capability value of the second logical core.

16. The method of claim 9, wherein the disabling of the second logical core of the physical processor core of the second type, and the not disabling the first logical core of the physical processor core of the second type, comprises modifying a control value, of an operating system, that sets a maximum percentage of logical processors that are to be in an un-parked state.

17. A non-transitory machine-readable medium that stores code that when executed by a machine causes the machine to perform a method comprising:
receiving a request to execute a set of threads of a foreground application on a hardware processor comprising a first plurality of physical processor cores of a first type that implements a plurality of logical processor cores of the first type, and a second plurality of physical processor cores of a second type, wherein each core of the second type implements a plurality of logical processor cores of the second type;
determining if the set of threads of the foreground application is to use more than a threshold number of logical processor cores and less than or equal to a total number of the first plurality of physical processor cores of the first type and the second plurality of physical processor cores of the second type; and
disabling a second logical core of a physical processor core of the second type, and not disabling a first logical core of the physical processor core of the second type, in response to a determination that the set of threads of the foreground application is to use more than the threshold number of logical processor cores and less than or equal to the total number of the first plurality of physical processor cores of the first type and the second plurality of physical processor cores of the second type.

18. The non-transitory machine-readable medium of claim 17, wherein the method further comprises:
determining if a set of threads of a background application that is to execute on the first plurality of physical processor cores of the first type or the second plurality of physical processor cores of the second type is to contend for any logical core that is to execute the set of threads of the foreground application when the second logical core is disabled; and
not disabling the second logical core in response to a determination that the set of threads of the background application that is to execute on the first plurality of physical processor cores of the first type or the second plurality of physical processor cores of the second type is to contend for any logical core that is to execute the set of threads of the foreground application when the second logical core is disabled.

19. The non-transitory machine-readable medium of claim 17, wherein each core of the first type is to implement a single logical processor core of the first type.

20. The non-transitory machine-readable medium of claim 17, wherein the method further comprises, in response to the determination that the set of threads of the foreground application is to use more than the threshold number of logical processor cores and less than or equal to the total number of the first plurality of physical processor cores of the first type and the second plurality of physical processor cores of the second type:
disabling each second logical core of each physical processor core of the second type that is to execute a thread of the set of threads of the foreground application;
not disabling each first logical core of each physical processor core of the second type that is to execute a thread of the set of threads of the foreground application; and
not disabling each second logical core of each physical processor core of the second type that is not to execute a thread of the set of threads of the foreground application.

21. The non-transitory machine-readable medium of claim 17, wherein the method further comprises, in response to the determination that the set of threads of the foreground application is to use more than the threshold number of logical processor cores and less than or equal to the total number of the first plurality of physical processor cores of the first type and the second plurality of physical processor cores of the second type, disabling each second logical core of each physical processor core of the second type.

22. The non-transitory machine-readable medium of claim 17, wherein the threshold number of logical processor cores is a single logical processor core.

23. The non-transitory machine-readable medium of claim 17, wherein the method further comprises generating, by a thread runtime telemetry circuit of the hardware processor, an energy efficiency capability value or a performance capability value for each logical processor core of the hardware processor, wherein the disabling of the second logical core of the physical processor core of the second type, and the not disabling the first logical core of the physical processor core of the second type, comprises lowering the energy efficiency capability value or the performance capability value of the second logical core.

24. The non-transitory machine-readable medium of claim 17, wherein the disabling of the second logical core of the physical processor core of the second type, and the not disabling the first logical core of the physical processor core of the second type, comprises modifying a control value, of an operating system, that sets a maximum percentage of logical processors that are to be in an un-parked state.
